(19) United States
(12) Patent Application Publication
(10) Pub. No.: US 2013/0141750 A1
(43) Pub. Date: Jun. 6, 2013

(54) CHECKING APPARATUS, CONTROL METHOD OF CHECKING APPARATUS, AND STORAGE MEDIUM

(71) Applicant: Canon Kabushiki Kaisha, Tokyo (JP)

(72) Inventor: Katsunari Suzuki, Yokohama-shi (JP)

(73) Assignee: CANON KABUSHIKI KAISHA, Tokyo (JP)

(21) Appl. No.: 13/684,038

(22) Filed: Nov. 21, 2012

(30) Foreign Application Priority Data
Dec. 1, 2011 (JP) 2011-263388

(51) Int. Cl. G06F 3/12

(52) U.S. Cl. CPC G06F 3/1235
USPC 358/1.14

(57) ABSTRACT

After printing has been normally performed, a printed product which has been divided into small portions and discharged to each output tray are stacked in a page order, so that a normal printed product including one set of pages is acquired.

### BACKGROUND OF THE INVENTION

1. Field of the Invention

The present invention relates to a checking apparatus, a control method of the checking apparatus, and a storage medium.

2. Description of the Related Art

Conventionally, Japanese Patent Application Laid-Open No. 2005-144797 discusses a sheet processing apparatus in which a printing apparatus discharges to different sheet discharge destinations, a sheet on which an image affected by a paper jam or switching of a sheet feed stage is printed, and a sheet on which the image is normally printed.

According to such a technique, a user becomes capable of confirming the degree of the effect, by sorting the sheet on which the image affected by a paper jam or switching of the sheet feed stage is printed and the sheet on which the image is normally printed.

Further, there is a checking apparatus which determines whether an output printed product is normal, regardless of the occurrence of a paper jam or switching of the sheet feed stage. If the checking apparatus performs checking and determines that the checking result is no good (NG), the output sheet which is determined as checking NG is output to an output unit different from a normal output unit, and the image forming processing is continued. As a result, productivity can be improved. However, in such a case, since the sheet which is determined as checking NG and the sheet which is not determined as checking NG are stacked on different sheet discharge units, an original position of the sheet which is determined as checking NG becomes lost.

When the sheet processing apparatus performs recovery printing with respect to the sheet which is determined as checking NG in the above-described state, the following operation becomes necessary. When the user is to insert the recovery printing sheet in a correct position, it becomes necessary for the user to search for the correct inserting position and insert the sheet in that position. Such a burdensome operation causes extra moves, and a workload for correctly printing and outputting the sheet increases.

### SUMMARY OF THE INVENTION

According to an aspect of the present invention, a checking apparatus for checking a printed product includes a determination unit configured to check whether the printed product is normal, and a control unit configured to control, in the case where the determination unit has determined that the printed product is normal, the printed product to be discharged to a first sheet discharge unit, in the case where the determination unit has then determined that the printed product is not normal, the printed product to be discharged to a second sheet discharge unit different from the first sheet discharge unit, and in the case where the determination unit has further determined that the printed product is normal, the printed product to be discharged to a third sheet discharge unit different from the first sheet discharge unit and the second sheet discharge unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an example of an image forming system.

FIG. 2 is a block diagram illustrating a configuration of a printer control unit.

FIG. 3 is a cross-sectional view illustrating a configuration of a printer unit.

FIG. 4 is a cross-sectional view illustrating an example of a configuration of a finisher unit.

FIG. 5 is a block diagram illustrating a configuration of the image forming system.

FIGS. 6A and 6B are block diagrams illustrating control configurations of the finisher unit.

FIG. 7 is a block diagram illustrating in detail a checking unit in a checking apparatus.

FIGS. 8A and 8B illustrate a skew detection processing performed by the checking apparatus.

FIGS. 9A, 9B, and 9C illustrate checking states in the checking apparatus.

FIG. 10 is a flowchart illustrating a control method of the checking apparatus.

FIG. 11 illustrates a state of job processing to be performed in the image forming system.

FIG. 12 illustrates a state of page processing to be performed in the image forming system.

FIG. 13 is a flowchart illustrating a control method of the checking apparatus.

FIG. 14 illustrates an example of a user interface (UI) screen displayed on the image forming system.

FIGS. 15A and 15B illustrate examples of the UI screen displayed on the image forming system.

FIG. 16 illustrates the state of page processing to be performed in the image forming system.

FIG. 17 illustrates a document discharge state in the finisher unit.

FIG. 18 is a flowchart illustrating a control method of the checking apparatus.

FIGS. 19A and 19B illustrate examples of the UI screen displayed on the image forming system.

FIG. 20 is a flowchart illustrating a control method of the checking apparatus.

### DESCRIPTION OF THE EMBODIMENTS

Various exemplary embodiments, features, and aspects of the invention will be described in detail below with reference to the drawings.

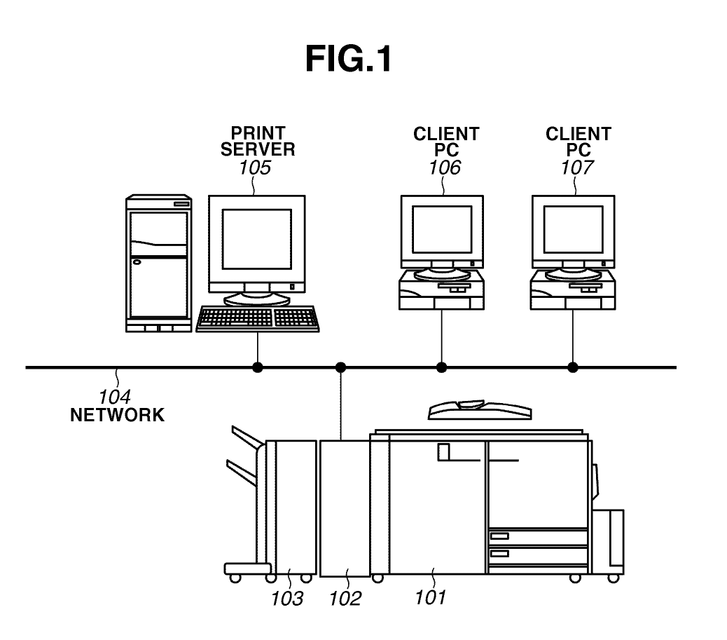

A first exemplary embodiment according to the present invention will be described below. FIG. 1 illustrates a configuration of an example of the image forming system to which the sheet processing apparatus according to the present exemplary embodiment is to be applied. According to the present exemplary embodiment, an image forming apparatus, the checking apparatus, and the sheet processing apparatus are connected in the image forming system to configure a conveyance path for performing in-line conveyance of a print output sheet. The sheet processing apparatus includes a sheet sorting unit that sorts the sheets, and a sheet conveyance switching unit that controls a conveyance destination of the print output sheets. Further, the sheet processing apparatus controls the sheet discharge destinations of the printed sheets, and of the printed sheets determined to be reprinted by performing the checking processing as will be described below. The sheet processing apparatus performs above-described control according to discharge sheet control information based on the checking result acquired by the checking apparatus.

Referring to FIG. 1, an image forming apparatus 101 processes various input data input from client personal computers (PC) 106 and 107 or a print server 105 via a network 104, and performs output for printing. A checking apparatus 102 receives the print output from the image forming apparatus 101 and checks the output content. A finisher unit 103 receives output sheets checked by the checking apparatus 102, and sorts the sheets for conveyance to predetermined output units. The image forming apparatus 101 is connected to the external print server 105 and the client PC 106 and 107 via the network 104.

The checking unit 102 is connected to the image forming apparatus 101 on one-on-one basis via a communication cable. Further, the finisher unit 103 is connected to the image forming apparatus 101 on one-on-one basis via a different communication cable. According to the present exemplary embodiment, an in-line checking device for continuously performing image forming, image checking, and finishing is described.

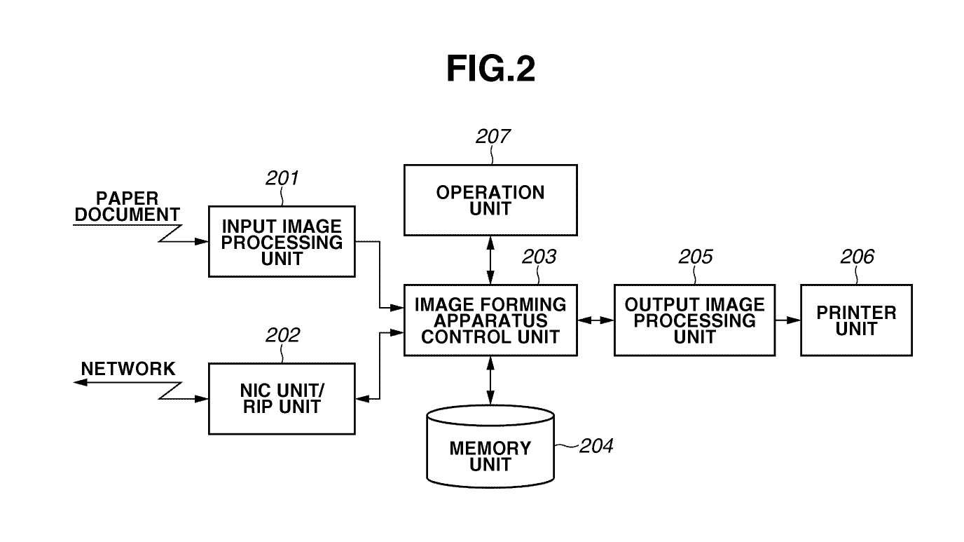

The configuration of the image forming apparatus will be described below. FIG. 2 is a block diagram illustrating the configuration of a printer control unit in the image forming apparatus 101 illustrated in FIG. 1. Referring to FIG. 2, an input image processing unit 201 reads a paper document using an image reading apparatus such as a scanner, and performs predetermined image processing on the read image data. A network interface card (NIC) unit in a NIC unit/raster image processing (RIP) unit 202 transmits to the RIP unit the image data (i.e., mainly page description language (PDL) data) input via the network. The NIC unit also transmits to the outside via the network the image data and apparatus information of the image forming apparatus. Further, the RIP unit in the NIC unit/RIP unit 202 analyzes the input PDL data and performs RIP rasterization. An image forming apparatus control unit 203 controls the input data and the image data to be output. Further, the image data input to the image forming apparatus control unit 203 is temporarily stored in a memory unit 204. The image data stored in the memory unit 204 is temporarily stored, and called as necessary. An output image processing unit 205 performs image processing for printing the image, and transmits the result to a printer unit 206.

The printer unit 206 feeds the sheets, and sequentially prints on the sheets the image data generated in the output image processing unit 205. An operation unit 207 includes a display unit which displays the UI screen for the user to select various flows and functions as described above, and operate on to issue instructions. Further, the operation unit 207 includes soft buttons and hard keys for receiving the instructions with respect to the display unit.

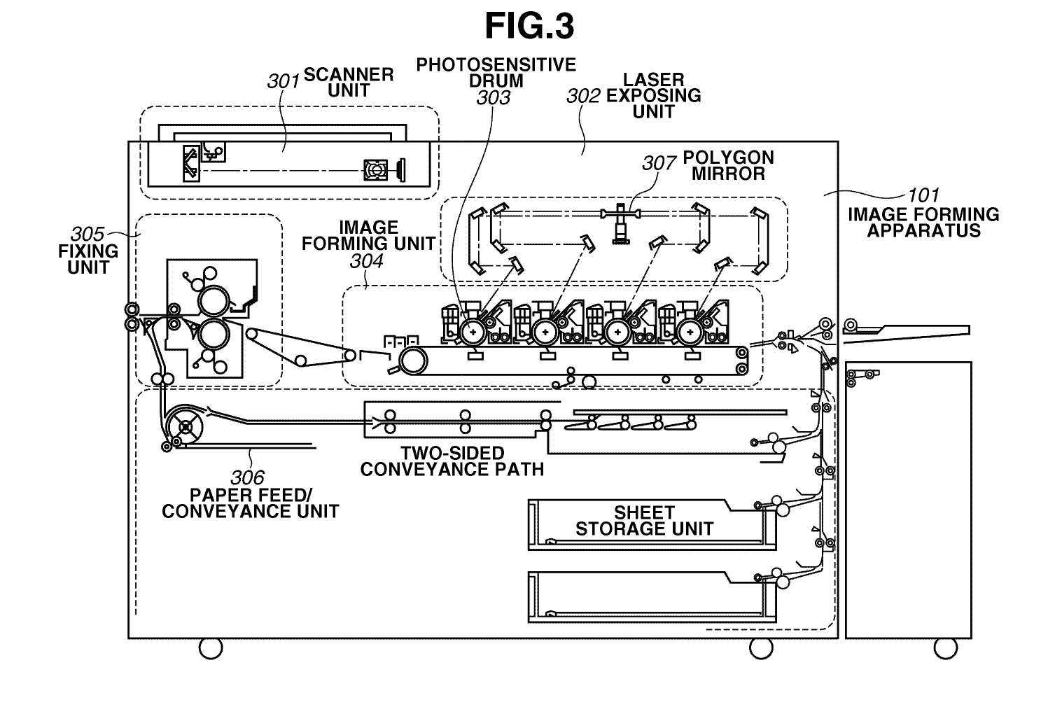

FIG. 3 is a cross-sectional view illustrating the configuration of the printer unit 206 in the image forming apparatus 101 in FIG. 1. Referring to FIG. 3, the image forming apparatus 101 includes a scanner unit 301, a laser exposing unit 302, a photosensitive drum 303, an image forming unit 304, a fixing unit 305, a paper feed/conveyance unit 306, and a printer control unit illustrated in FIG. 2 controlling the elements therein. The scanner unit 301 irradiates the document placed on a document stage plate, optically reads a document image, converts the image to an electric signal, and generates the image data.

The laser exposing unit 302 causes an optical beam, such as laser light, modulated according to the image data to be incident to a rotating polygon mirror that rotates at constant angular velocity. The photosensitive drum 303 is then irradiated with reflected scanning light

The image forming unit 304 rotatably-drives the photosensitive drum 303, charges the photosensitive drum 303 using a charging device, and develops employing toner a latent image formed by the laser exposing unit 302 on the photosensitive drum 303. The image forming unit 304 then transfers the toner image to the sheet, and collects minute toner which has not been transferred and is remaining on the photosensitive drum 303. The image forming unit 304 includes four developing units (i.e., developing stations) that perform the above-described series of electrophotographic process.

More specifically, the four-series of developing units arranged in an order of cyan (C), magenta (M), yellow (Y), and black (K) sequentially perform the image forming operation for M, Y, and K, after a predetermined time has elapsed from when the cyan developing station has started to form the image. A full-color toner image is thus transferred to the sheet without color misregistration by performing such timing control. According to the present exemplary embodiment, a color printer is assumed. However, it is not limited thereto, and if a monochrome printer is used, only the black developing station is included.

The fixing unit 305 is configured with a combination of rollers and belts, and includes a heat source such as a halogen heater built-in. The fixing unit 305 melts and fixes by applying heat and pressing force the toner on the sheet on which the toner image has been transferred by the image forming unit 304.

The paper feed/conveyance unit 306 includes one or more sheet storage units represented by a sheet cassette or a paper deck. The paper feed/conveyance unit 306 separates one sheet from a plurality of sheets stored in the sheet storage unit according to the instruction from the printer control unit, and conveys the sheet to the image forming unit 304 and the fixing unit 305. The sheet is then conveyed, so that the developing stations transfer the toner image of each color thereto, and the full color image is thus formed thereon. If the image is to be formed on both sides of the sheet, control is performed so that the sheet passes through a conveyance path which re-conveys to the image forming unit 304 the sheet that has passed through the fixing unit 305.

The printer control unit illustrated in FIG. 2 communicates with the image forming control unit that controls the entire image forming apparatus 101, and performs control according to the instruction from the image forming control unit. Further, the printer control unit illustrated in FIG. 2 manages the status of each of the above-described scanner unit 301, laser exposing unit 302, image forming unit 304, fixing unit 305, and paper feed/conveyance unit 306, and issues instructions so that the processing units smoothly operate in consistency.

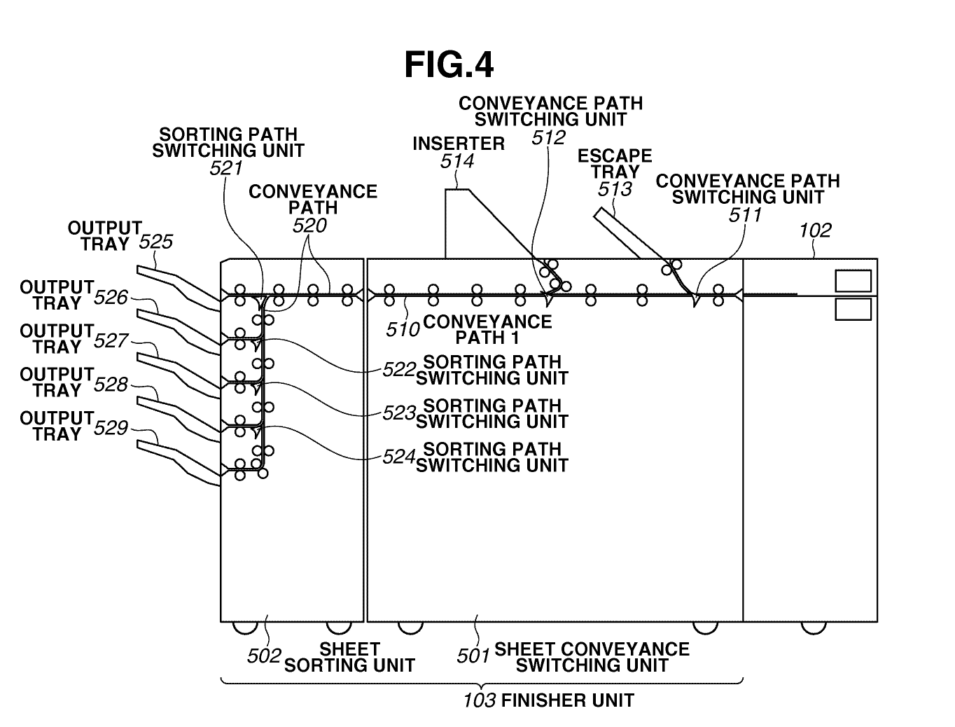

The configuration example of the finisher unit will be described below. FIG. 4 is a cross-sectional view illustrating an example of a configuration of the finisher unit 103 illustrated in FIG. 1. Referring to FIG. 4, the sheet discharged from the checking apparatus 102 arranged upstream with respect to the finisher unit 103 enters the finisher unit 103. The finisher unit 103 includes a sheet conveyance switching unit 501 and a sheet sorting unit 502. The sheet conveyance switching unit 501 includes a conveyance path 510, a conveyance path switching unit 511, and a conveyance path switching unit 512.

The conveyance path 510 conveys the sheet discharged from the checking apparatus 102. The conveyance path switching unit 511 switches a conveyance direction of the sheet conveyed from the checking unit 102 according to whether the checking result of the conveyed sheet is NG. The conveyance path switching unit 512 switches the conveyance direction when an inserter 514 separately inserts a sheet to the conveyance path.

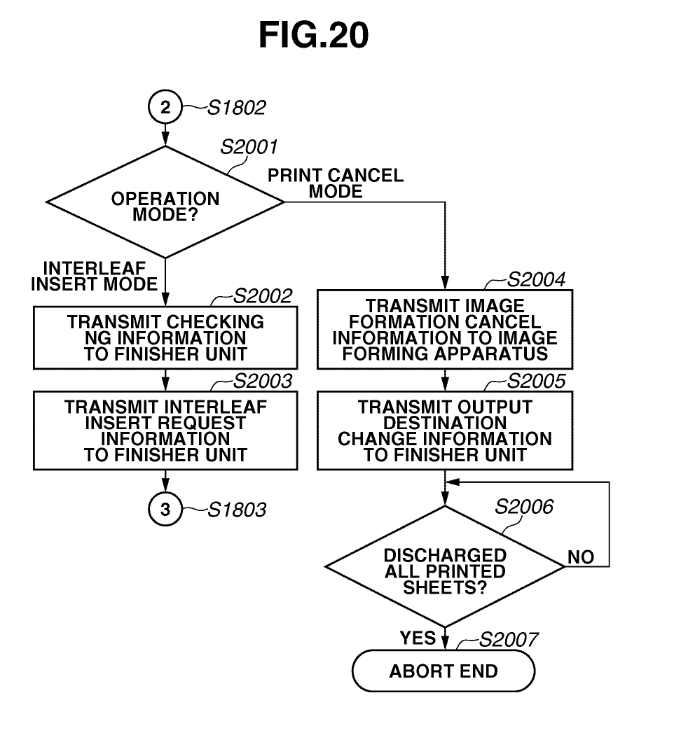

An escape tray 513 on which the sheet whose conveyance direction has been switched by the conveyance path switching unit 511 is stacked, and the inserter 514 for separately inserting the sheet to the conveyance path 510 are disposed outside the sheet conveyance switching unit 501. The inserter 514 in the finisher unit 103 corresponding to the first and second sheet discharge units performs a processing to insert an interleaf in the conveyance path that conveys the printed sheet between the checking apparatus 102 and the output tray. The insertion processing will be described in detail below with reference to a flowchart illustrated in FIG. 20.

If the sheet conveyed at the conveyance path switching unit 511 is determined by the checking apparatus 102 that the checking result is NG, the conveyance direction of the sheet is switched to the escape tray 513. If the sheet is determined that the sheet is not checking NG, the conveyance direction of the sheet is switched so that the sheet continues to be conveyed on the conveyance path.

If there is no sheet conveyed on the conveyance path 510, the sheet set on the inserter 514 can be inserted in the conveyance path switching unit 512. If there is an instruction from the operation unit 207 to insert the sheet, the sheet can be inserted at predetermined timing. The sheet which is directly conveyed on the conveyance path inside the sheet conveyance switching unit 501 is discharged to the sheet sorting unit 502.

The sheet sorting unit 502 includes a conveyance path 520 which receives and conveys the sheet discharged from the sheet conveyance switching unit 501, and sorting path switching units 521, 522, 523, and 524.

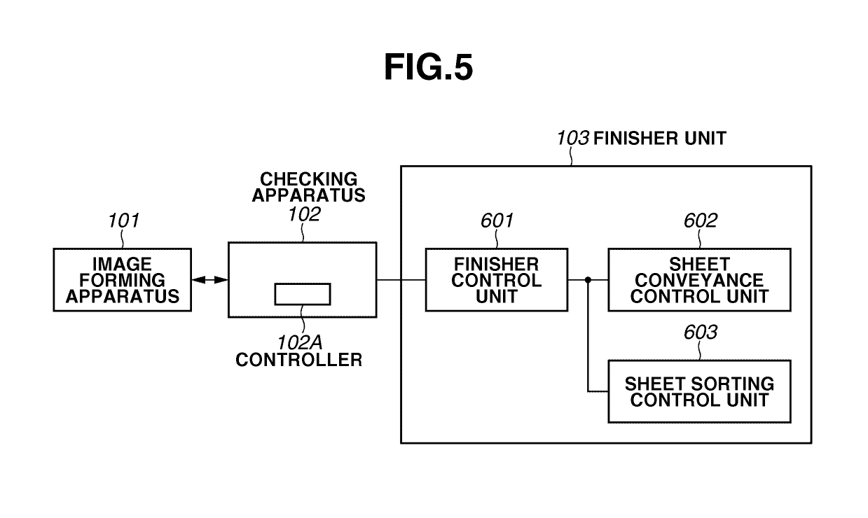

Further, output trays 525, 526, 527, 528, and 529 are disposed outside the sheet sorting unit 502. The sorting path switching unit 521 is capable of switching the sheet conveyed on the conveyance path 520 to be conveyed to the output tray 525 or to be continuously conveyed on the conveyance path 520. A finisher control unit 601 illustrated in FIG. 5 sorts to the plurality of the output trays such as 525, 526, 527, 528, and 529 and discharges the printed sheets that have been checked.

The path switching unit 522 is similarly capable of switching the sheet conveyed on the conveyance path 520 to be conveyed to the output tray 526 or to be continuously conveyed on the conveyance path 520. Further, the path switching unit 523 is similarly capable of switching the sheet to be conveyed to the output tray 527 or to be continuously conveyed on the conveyance path 520. Furthermore, the path switching unit 524 is similarly capable of switching the sheet to be transferred to the output tray 528 or the output tray 529. As a result, the sheet input to the sheet sorting unit 502 is discharged to one of the output trays 525, 526, 527, 528, and 529. According to the present exemplary embodiment, there are five output trays. However, there may be more than five output trays.

FIG. 5 is a block diagram illustrating the control configuration of the finisher unit 103 illustrated in FIG. 1. The image forming apparatus control unit 203 in the image forming apparatus 101 and the finisher control unit 601 in the finisher unit 103 are connected via a dedicated communication line.

Referring to FIG. 5, the finisher control unit 601 receives from the image forming apparatus 101, finisher setting information according to the job. The finisher control unit 601 then communicates, based on the received setting information, with each of the control units to be described below controlling each of the functions in the finisher unit 103. A sheet conveyance control unit 602 performs switching control of the conveyance path to guide the sheet to the various sheet discharge destinations based on the control information of the job transmitted from the finisher control unit 601.

More specifically, the sheet conveyance control unit 602 controls the conveyance path switching unit 511 to switch the sheet to be conveyed to the escape tray 513, and controls the conveyance path switching unit 512 to insert the sheet set on the inserter 514 to the conveyance path 510. A sheet sorting control unit 603 conveys the sheet to each of the output trays 525, 526, 527, 528, and 529 based on the control information of the job transmitted from the finisher control unit 601.

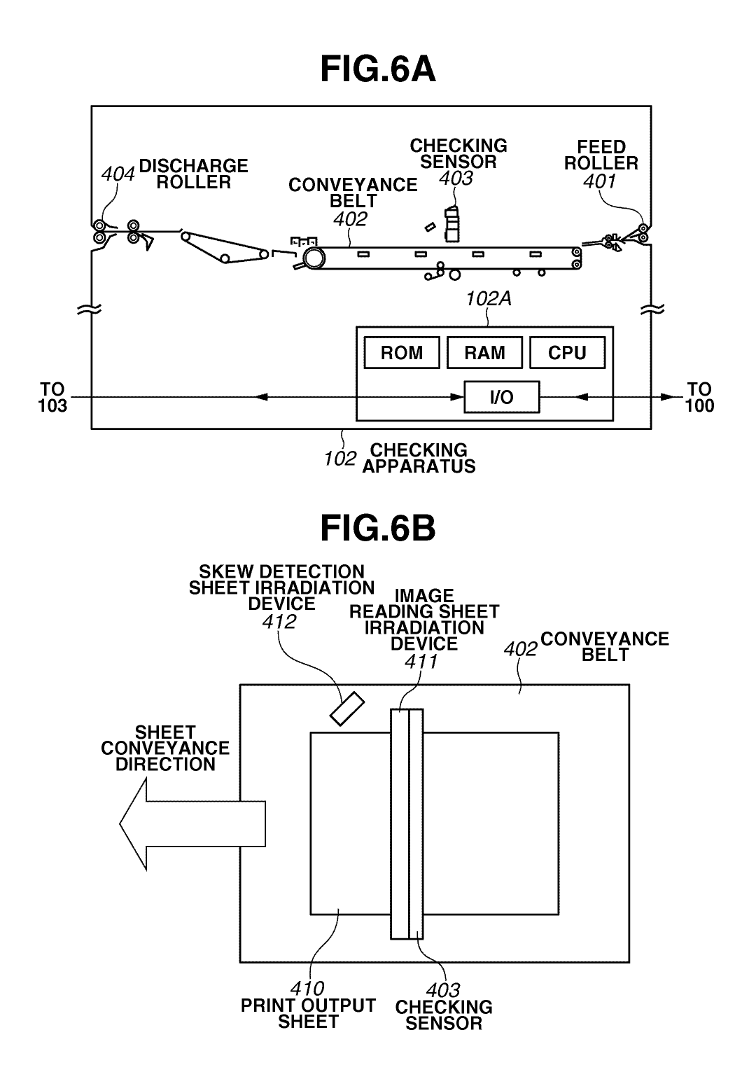

An internal configuration of the checking apparatus 102 will be described below. FIGS. 6A and 6B illustrate the configurations of the checking apparatus 102 illustrated in FIG. 1. More specifically, FIG. 6A corresponds to a cross-sectional view illustrating an internal structure of the checking apparatus 102, and FIG. 6B corresponds to a plane view illustrating an image reading processing performed by a checking sensor in the checking apparatus 102.

Referring to FIG. 6A, a feed roller 401 pulls into the checking apparatus 102, the sheet which has been printed by and output from the image forming apparatus 101. A checking sensor 403 disposed above the conveyance belt 402 then reads and determines the image on the print output sheet while the print output sheet is transferred on a conveyance belt 402. The determination result of image quality read by the checking sensor 403 is thus transmitted to the finisher unit 103. Upon the checking sensor 403 performing image quality determination, the print output sheet is output from a discharge roller 404.

According to the present exemplary embodiment, although it is not illustrated, the checking sensor 403 may be configured such that the checking sensor 403 also read the image from below the conveyance belt 402 for reading a two-sided print output sheet. Further, according to the present exemplary embodiment, a random access memory (RAM) in a controller 102A illustrated in FIG. 6A is used to store the following information. The RAM stores the information on the page determined by the checking processing to be reprinted, associated with identification information of the output tray to which the print output sheet corresponding to the page before the page to be reprinted has been discharged. The information which associates the print output sheet with the identification information of the output tray to which the printed sheet has been discharged is transmitted as sheet discharge control information from the controller 102A to the finisher control unit 601.

FIG. 6B is a plane view illustrating a portion of the conveyance belt 402 as viewed from a top surface. Referring to FIG. 6B, the checking sensor 403 includes a line sensor which reads line-by-line a full image of the printed sheet 410 conveyed as illustrated therein.

When the sheet is to be read by the checking sensor 403, an image reading sheet irradiation device 411 irradiates the print output sheet. When the sheet is conveyed on the conveyance belt 402, a skew detection sheet irradiation device 412 irradiates the printed sheet, so that whether the sheet is skewed with respect to a sheet conveyance direction is read. According to the present exemplary embodiment, the skew detection sheet irradiation device 412 irradiates from an oblique direction with respect to the sheet being conveyed on the conveyance belt 402. The checking sensor 403 thus reads a shadow image of an edge of the sheet, and detects the skew.

According to the present exemplary embodiment, the checking sensor 403 reads the shadow image of the sheet edge. However, a reading sensor other than the checking sensor 403 may be used.

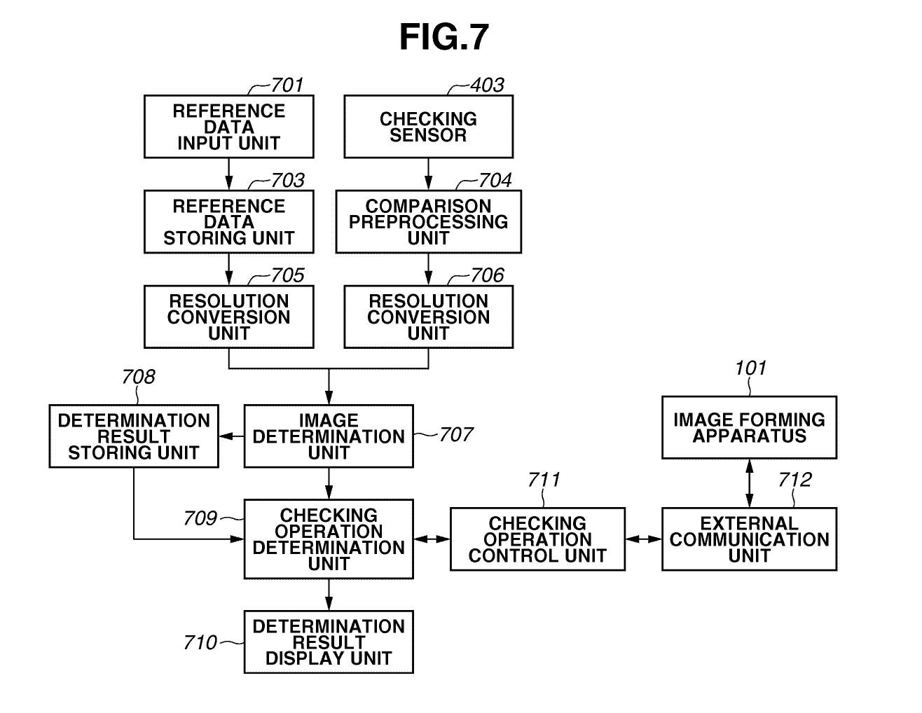

FIG. 7 is a block diagram illustrating in detail the checking unit in the checking apparatus 102 illustrated in FIG. 1. Referring to FIG. 7, the image information acquired by scanning the printed product read by the checking sensor 403 illustrated in FIG. 6B is converted to the electric signal. A comparison preprocessing unit 704 then performs correction, such as sheet skew correction, before performing comparison. The sheet skew correction processing is performed as described below.

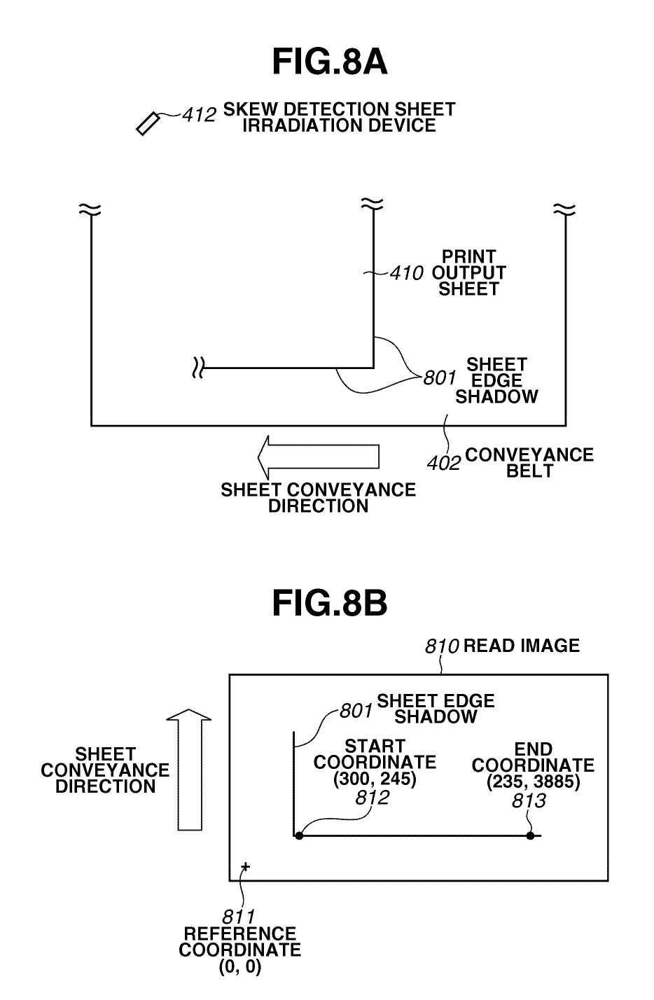

The conveyance belt 402 conveys the sheet pulled into the checking apparatus 102. The checking sensor 403 then reads the shadow of the sheet edge generated by the skew detection sheet irradiation device 412 irradiating the sheet, and detects the difference between the detected shadow and a predetermined angle. The image skew detection and determination processing will be described below with reference to FIGS. 8A and 8B.

FIGS. 8A and 8B illustrate the skew detection processing performed by the checking apparatus according to the present exemplary embodiment. Referring to FIG. 8A, the printed sheet 410 conveyed on the conveyance belt 402 is irradiated by the skew detection sheet irradiation device 412 arranged in the oblique direction with respect to the sheet conveyance direction above the conveyance belt 402. Upon the skew detection sheet irradiation device 412 irradiating the print output sheet 410 with light, a sheet edge shadow 801 is generated at a rear edge of the print output sheet 410.

The checking sensor 403 then reads the sheet edge shadow 801. The comparison preprocessing unit 704 performs binarization and edge detection on the shadow image read by the checking sensor 403, so that a tilt of the shadow image is detected. In such a case, the sheet edge shadow in either the sheet conveyance direction or a direction perpendicular to the sheet conveyance direction may be used in performing tilt detection of the sheet edge shadow. Further, the sheet edge shadow in both directions may be acquired, and an average may be calculated in performing tilt detection. If the result of performing binarization and edge detection on the image data read by the checking sensor 403 becomes as illustrated in FIG. 8B for example, a reference coordinate 811 is determined. A predetermined start coordinate 812 and an end coordinate 813 are then determined on the image of the sheet edge shadow 801, and relative coordinates of the start coordinate 812, and the end coordinate 813 with respect to the reference coordinate 811 are determined.

If the reference coordinate 811 is (0, 0), the start coordinate 812 is (300, 245), and the end coordinate 813 is (235, 3885) as illustrated in FIG. 8B, the tilt θ (deg) between the start coordinate 812 and the end coordinate 813 is acquired by equation 1.

θ=tan⁻¹(235−300)/((3885−245)=1.023(deg) equation 1

As a result, the comparison preprocessing unit 704 detects that the printed sheet is tilted 1.023 degrees in a clockwise direction with respect to the sheet conveyance direction. The comparison preprocessing unit 704 thus rotates the entire image data read by the checking sensor 403 based on the detected tilt angle and tilt rotation angle information.

After the comparison preprocessing unit 704 has performed comparison preprocessing correction, the image data is transmitted to a resolution conversion unit 706 illustrated in FIG. 7. On the other hand, reference data, i.e., original data to be compared with the processed image data, is input from a reference data input unit 701 and stored in a reference data storing unit 703. The reference data may be input from the image forming apparatus 101 via the network 104 or directly from some importing interface included in the checking apparatus 102.

A resolution conversion unit 705 converts the reference data, and the resolution conversion unit 706 converts the scanned data of the printed product, to similar resolutions (e.g., 300 dpi) to be comparable with one another. The data are then transmitted to an image determination unit 707.

The image determination unit 707 compares the read image data received from the resolution conversion unit 706 and the reference data received from the resolution conversion unit 705, and determines whether a checking result is OK or NG. If the image determination unit 707 determines that the checking result is NG, the image determination unit 707 confirms page order information of the page and checked content which has been determined as NG. The image determination unit 707 combines the above-described information and generates data after image determination. The data after image determination is stored in a determination result storing unit 708 and transmitted to a checking operation determination unit 709. The determination result storing unit 708 updates the number of occurrences of the combination of the page order information and the checked content in the data after image determination, and updates a checking NG database (NGDB).

The checking operation determination unit 709 uses the data after image determination received from the image determination unit 707, and acquires from the NGDB a number of checking NGs that have occurred for such a combination of the data after image determination. Further, the checking operation determination unit 709 determines whether the acquired number of checking NGs that have occurred is greater than a predetermined threshold value. If the number of checking NGs that have occurred is greater than a predetermined threshold value, the checking operation determination unit 709 displays such a result on a determination result display unit 710 as necessary.

Further, the checking operation determination unit 709 performs various types of control with respect to a checking apparatus control unit 711. Furthermore, the checking operation determination unit 709 issues to the image forming apparatus 101 via an external communication unit 712 an image forming operation stop request notification.

A determination method performed in the checking apparatus will be described below. The reference data and the print output data are respectively converted to similar resolutions as desired by the resolution conversion units 705 and 706. Further, matching is performed between each pixel in each data using bitmap data. According to the present exemplary embodiment, difference comparison is performed between each pixel value.

The difference between the pixel values is acquired by the checking sensor 403 reading reflected light from the printed sheet 410 which has been irradiated by the image reading sheet irradiation device 411. The difference between density values is then calculated for each pixel with respect to the read image data, and whether printing has been correctly performed is determined according to the difference value. For example, if the read image data is acquired by PDL printing, the rasterized PDL data is used as the reference data, and the read image data is compared with the rasterized PDL data. The resolution conversion units 705 and 706 respectively convert the reference data and the read image data to similar resolutions as desired, and matching is performed between each of the images using the bitmap data.

According to the present exemplary embodiment, both of the image data are divided into a plurality of blocks, each of which is 5 pixels by 5 pixels, and density comparison in red, green, and blue (RGB) or cyan, magenta, yellow, and key (CMYK) is performed for each pixel in each block. Whether to perform comparison in RGB or CMYK can be changed according to the image. For example, if the image data is color image data, comparison is performed in RGB, and if the image data is monochrome image data, comparison is performed in CMYK (i.e., only K).

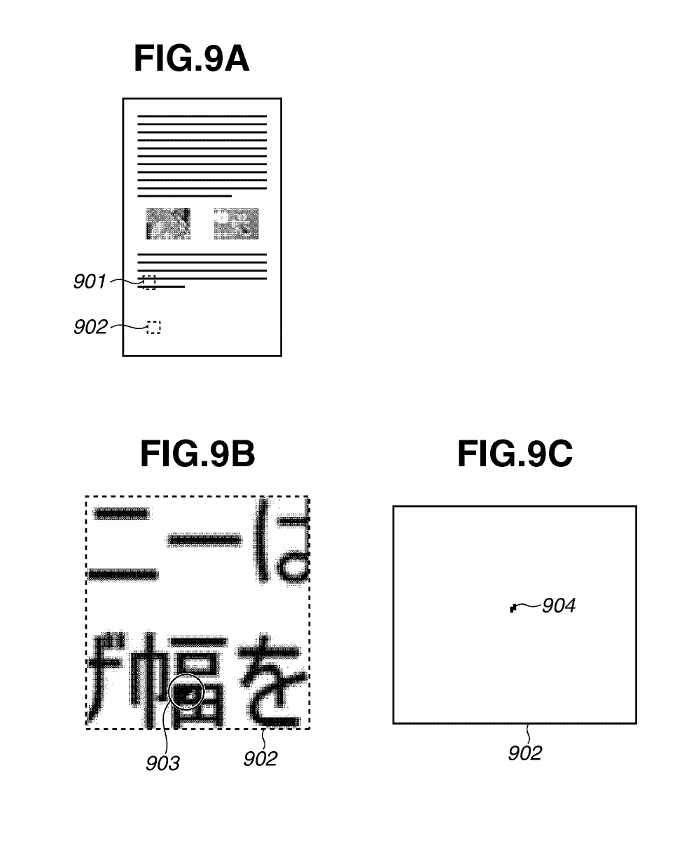

FIGS. 9A, 9B, and 9C illustrate examples of performing image comparison for each block of 5 pixels by 5 pixels. More specifically, FIG. 9A illustrates the image read by the checking sensor 403, FIG. 9B illustrates a portion of the reference image data, and FIG. 9C illustrates another portion. The density data is multi-valued data of 0 to 255, and a comparison value is acquired by the following equation 2.

Comparison value=[value of the data acquired by scanning the printed sheet]−[reference image density data value] equation 2

An absolute value of the comparison value calculated using equation 2 and a preset tolerable density difference are then compared as in the following equation 3.

|comparison value|≦tolerable density difference equation 3

If the absolute value of the comparison value is less than or equal to the tolerable density difference, the pixel is determined as OK, and if not, the pixel is determined as NG. In the example illustrated in FIG. 9A, there is dust on a position of a region 902, so that the density value is read to be less than that of an originally black pixel value. In such a case, if a density difference threshold value is set as 40, an image density data value of a region 901 as 255, and an image density of the region 902 as 127, equation 3 becomes as follows, i.e., equation 4.

|comparison value|=|127−255|=128 equation 4

Since 128 is not less than or equal to 40, i.e., the density threshold value, the pixel is determined as NG.

As described above, according to the present exemplary embodiment, the image determination unit 707 performs determination for each pixel in the block of 5 pixels by 5 pixels, and acquires an OK determination rate for each block. The image determination unit 707 then compares the acquired OK determination rate for each block with an OK determination threshold value set by a desired method. For example, if the OK determination threshold value is designated as 90%, and there is 1 NG pixel in the block, comparison is performed as follows, i.e., in equation 5.

Determination rate (96%)>OK determination threshold value (90%) equation 5

As a result, the image determination unit 707 determines that the checking result of the block is OK. The image determination unit 707 performs the above-described checking determination processing for the entire print output sheet. If the image determination unit 707 determines that all blocks are OK, the image determination unit 707 determines that the checking result of the sheet is OK. The image determination unit 707 determines the sheet as OK or NG for all other cases depending on conditions.

The example in which the checking result is determined as NG will be described below with reference to FIGS. 9A, 9B, and 9C. More specifically, FIG. 9A illustrates the read image data of the print output sheet which has been read by the checking sensor 403 in the checking apparatus 102. FIG. 9B illustrates an enlarged image of the region 901 illustrated in FIG. 9A.

Referring to FIG. 9B, deformation is generated in a character in a portion 903 marked by a circle. The deformation is a phenomenon in which the image of a portion which is actually white, surrounded by a black character portion in the character in the original document image data, is observed to be deformed. Such a phenomenon occurs mainly because, when the latent image is formed, a charge forming the latent image is infiltrated into a closed, since space within enclosed region of the black character portion is narrow. In such a case, the checking apparatus 102 determines that the result of the difference comparison of the pixel value is NG.

On the other hand, the example illustrated in FIG. 9C is an enlarged image of the region 902 illustrated in FIG. 9A, in which a region 904 appears as a singular noise image with respect to a surrounding white region. Such a noise image is not related to the document image data in which the character is deformed as described above. The noise image is minute dust which has accidentally become attached to the position and read by the checking sensor 403. In such a case, the checking apparatus 102 determines that the result of the difference comparison of the pixel value is NG.

Control performed for discharging the printed sheet on which the image forming apparatus has formed the image and which is determined as NG as a result of checking determination performed by the checking apparatus according to the present exemplary embodiment will be described in detail below. Further, control performed for stacking and the printed sheet collating with a reprinted OK sheet according to the present exemplary embodiment will be described in detail below.

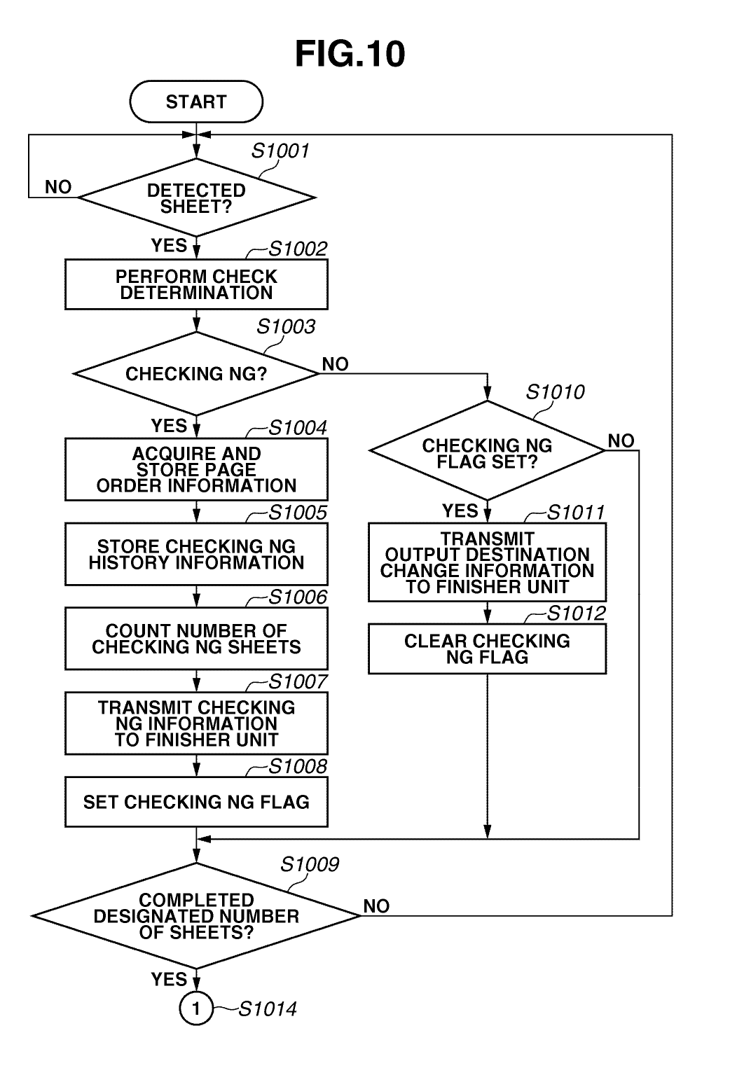

Switching of sheet conveyance according to the checking determination will be described below. FIG. 10 is a flowchart illustrating a control method of the checking apparatus according to the present exemplary embodiment. The example illustrated in FIG. 10 is a checking processing performed by the checking apparatus 102 included in the image forming system illustrated in FIG. 1. Each of the steps in the flowchart is realized by the controller 102A including the CPU, the ROM, the RAM, the input/output interface (I/F), which performs checking determination control in the checking apparatus 102 executing each step. Further, description will be made such that the CPU mainly operates as the determination unit. Furthermore, according to the present exemplary embodiment, a copy job will be described below for ease of description. However, checking printing may also similarly be performed on a print job via the network.

In step S1001, the CPU in the controller 102A determines whether the checking apparatus 102 has detected the printed sheet 410 conveyed from the image forming apparatus 101. In such a case, the CPU in the controller 102A determines using a sheet detection unit (not illustrated) disposed near the feed roller 401 illustrated in FIG. 6A, whether the printed sheet has been conveyed into the checking apparatus 102. If the CPU in the controller 102A determines that the printed sheet has not been detected (NO in step S1001), the CPU waits in step S1001 until the printed sheet is detected. If the CPU in the controller 102A determines that the printed sheet has been detected (YES in step S1001), the CPU in the controller 102A proceeds to step S1002.

In step S1002 and step S1003, the CPU in the controller 102A determines whether the result of the checking processing of the printed sheet 410 conveyed from the image forming apparatus 101 is NG. In such a case, the CPU in the controller 102A performs the checking determination processing described with reference to FIGS. 9A, 9B, and 9C. If the CPU in the controller 102A determines that the checking result is NG (YES in step S1003), the CPU in the controller 102A proceeds to step S1004. If the CPU in the controller 102A determines that the checking result is not NG (NO in step S1003), the CPU in the controller 102A proceeds to step S1010.

If the checking result is determined as NG in step S1003 (No in step S1003), in step S1004, the CPU in the controller 102A acquires the order information of the printed sheet which has been determined as checking NG, and stores the order information in the RAM in the controller 102A.

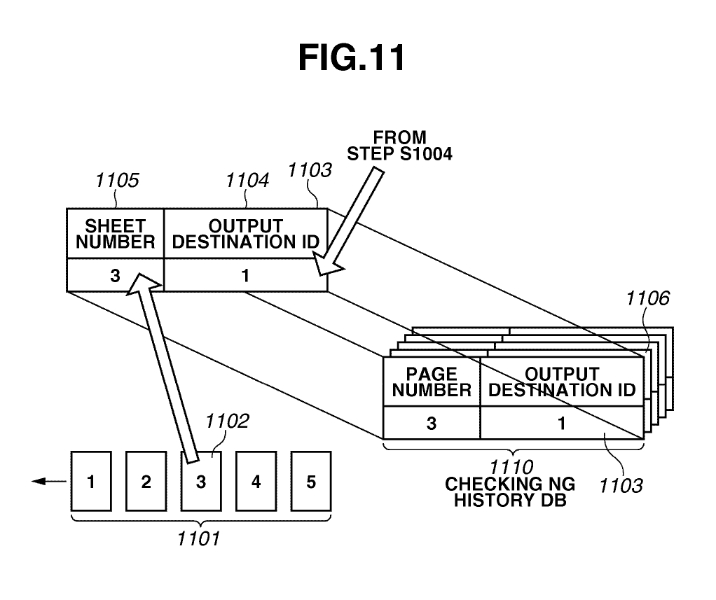

For example, if the CPU in the controller 102A determines that the checking result of a third printed sheet after submitting the copy print job is NG as illustrated in FIG. 11, the CPU in the controller 102A determines as follows. Specifically, the CPU in the controller 102A can determine that the sheet is the third input sheet by detecting the number of sheets using the sheet detection unit disposed near the feed roller 401. A series of printed sheets 1101 illustrated in FIG. 11 indicates in order the first, second, third, fourth, and fifth printed sheets of the copy print job, and a sheet 1102 indicates the third printed sheet which has been determined as checking NG.

In step S1005, the CPU in the controller 102A stores in the RAM in the controller 102A, output destination information (i.e., output destination ID=1 in the example illustrated in FIG. 11) as NG history information. The NG history information manages the history of the printed sheets which have been determined as checking NG. The output destination information indicates the output destination information to which the printed sheet which has been determined as checking NG was originally to be conveyed. The output destination is one of the output trays 525, 526, 527, 528, and 529 in the sheet sorting unit 502. For example, it is assumed that the user has set employing the operation unit 207, using all output trays in the copy print job. Further, it is assumed that the print output sheet which has been determined as checking NG is so determined as NG in an initial checking processing of the copy print job. In such a case, the output destination information indicates the output tray 525.

In step S1005, the CPU in the controller 102A may store the output destination information combined with the page order information acquired in step S1004. For example, history information 1103 illustrated in FIG. 11 includes a combination of a sheet number 1105 indicating the order of the sheet which is determined as checking NG, and an output destination identification (ID) 1104. The history information 1103 is sequentially stored in a NG history database (DB) 1110 (i.e., stored in the RAM in the controller 102A). According to the present exemplary embodiment, the output destination ID becomes as follows. ID=1 is assigned to the output tray 525, ID=2 to the output tray 526, ID=3 to the output tray 527, ID=4 to the output tray 528, and ID=5 to the output tray 529, in the sheet sorting unit 502.

Further, there may be a case where the checking results of two sheets are continuously determined as NG. In such a case, the output destination information of the second sheet becomes the same as the prior printed sheet determined as checking result NG. Referring to FIG. 11, it is assumed that the checking result of the fourth printed sheet is determined as checking result NG subsequent to the checking result of the third printed sheet being determined as checking NG. The sheet number thus becomes 4 (sheet number=4) and the output destination becomes 1 (output destination ID=1) in combination information 1106 in the NG checking result history DB 1110, subsequent to the history information 1103 in which checking result NG is combined.

In step S1006, the CPU in the controller 102A counts the number of sheets which has been determined as checking NG. For example, as described above, since the third print out sheet is determined as NG as a result in the initial checking processing, the sheet number information after counting becomes 1. The sheet number information after counting is stored in the RAM in the controller 102A.

In step S1007, the CPU in the controller 102A transmits to the finisher control unit 601 via the input/output I/F, checking NG information for conveying to the escape output the sheet which has been determined as checking NG as a result of the checking processing.

In step S1008, the CPU in the controller 102A sets a checking NG flag reserved in the RAM in the controller 102A. The checking NG flag will be described below.

In step S1009, the CPU in the controller 102A determines whether the designated number of sheets has been printed. For example, since the user has previously designated from the operation unit 207 the number of sheets to be printed on the copy print job, the CPU in the controller 102A can determine whether the print sheet number has reached the print sheet number information. If the CPU in the controller 102A determines that the designated number of sheets has not been reached (NO in step S1009), the CPU in the controller 102A returns to step S1001. On the other hand, if the CPU in the controller 102A determines that the designated number of sheets has been reached (YES in step S1009), the checking determination processing of the copy print job ends, even though a NG determination has occurred for a part of the print output sheets. The CPU in the controller 102A thus proceeds to step S1014. In step S1014, the CPU in the controller 102A waits for the subsequent checking determination processing after completing the checking determination processing of the copy print job.

As described above, there is a case where there are printed sheets which have been determined as checking NG as a result of checking processing. For example, the CPU in the controller 102A can determine that there are printed sheets which have been determined as checking NG, based on whether there is checking NG information stored in the checking NG history DB 1110 as illustrated in FIG. 11. If there are print output sheets which have been determined as checking NG, the user can select via the operation unit 207, whether to perform recovery printing with respect to the sheets which have been determined as checking NG. However, since the flowchart illustrated in FIG. 11 indicates a control flow performed in the checking apparatus 102, description on whether recovery printing is to be performed will be omitted.

The process performed in step S1010 and the subsequent steps in the case where the CPU in the controller 102A determines in step S1002 that the checking result of the print output sheet 410, which is input, is not NG will be described below.

In step S1010, the CPU in the controller 102A determines whether the checking NG flag is set on the RAM. The checking NG flag is set when the print output sheet 410 is determined as checking NG in step S1003 as described in step S1008. Accordingly, in this case the checking NG flag indicates that the print output sheet prior to the current print output sheet is determined as checking NG.

In step S1010, if the CPU in the controller 102A determines that the checking NG flag is set (YES in step S1010), the CPU in the controller 102A proceeds to step S1011. In step S1011, the CPU in the controller 102A transmits to the finisher control unit 601 via the input/output I/F, a notification of output destination change information to change the output destination of the print output sheet.

The case where the third printout sheet is determined as checking NG, and the fourth print out sheet is not determined as checking NG as illustrated in FIG. 11 will be described below. If the output trays 525, 526, 527, 528, and 529 are set as the output trays usable in the copy print job, and the first and second copy-printed sheets are output to the output tray 525, the subsequent tray becomes the output tray 526. As a result, it becomes necessary for the CPU in the controller 102A to transmit to the finisher control unit 601, output destination change information for changing the output destination to the output tray 526.

In step S1012, since the control operation for the checking NG flag has been completed according to the checking determination processing being determined as checking NG, the CPU in the controller 102A clears the checking NG flag. The CPU in the controller 102A then proceeds to step S1009.

On the other hand, if the CPU in the controller 102A determines that the checking NG flag is not set (NO in step S1010), it indicates that the current copy-printed sheet and the prior copy-printed sheet have not been determined as checking NG. As a result, the copy-printed sheets can be normally conveyed, and it is not necessary to perform control with respect to the finisher unit 103. The CPU in the controller 102A thus proceeds to step S1009.

As described above, if checking NG occurs in performing the print job, the checking apparatus 102 performs control so that the output destination of the copy-printed sheets is automatically changed.

The operations of the checking apparatus 102 and the finisher unit 103 in the case where following copy print job is executed will be described below with reference to the drawings for ease of understanding the present invention. Control of the print output sheet conveyance destination performed by the sheet processing apparatus based on the sheet discharge control information transmitted from the checking apparatus will be described below. The finisher control unit 601 illustrated in FIG. 5 collectively performs control of the sheet processing apparatus.

The finisher control unit 601 in the image forming system configured as illustrated in FIG. 5 performs control as follows based on the sheet discharge control information transmitted from the controller 102A in the checking apparatus 102. The finisher control unit 601 controls, each time it is determined that one of a plurality of pages is to be reprinted, the print out sheet determined to be reprinted to be discharged to a sheet discharge unit. As a result, the finisher control unit 601 performs control to discharge the print output sheet to be reprinted to the escape tray 513.

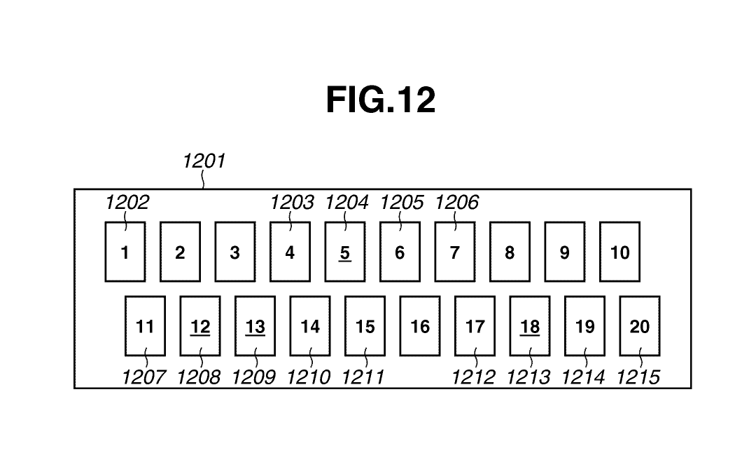

Further, the finisher control unit 601 performs control as follows based on the sheet discharge control information transmitted from the controller 102A in the checking apparatus 102. The finisher control unit 601 controls, each time it is determined that one of a plurality of pages is to be reprinted, to switch the output destinations of subsequent print output sheets that are determined to be normally printed, after the page determined to be reprinted. In such a case, the finisher control unit 601 performs control to switch the output destination to the output tray that is different from the output tray configuring the first sheet discharge unit to which the print out sheet determined as normally printed before the sheet determined to be reprinted has been discharged. A specific example will be described below with reference to FIG. 12.

Referring to FIG. 12, according to the present exemplary embodiment, the copy print job prints 20 sheets. The case where the checking NG determination occurs in the fifth (underlined in the FIG. 12) the twelfth, thirteenth, and eighteenth sheets in the print job will be described below.

The copy print job is capable of sequentially using three output trays among the output trays 525, 526, 527, 528, and 529. The other trays are reserved for other print jobs and thus cannot be used.

Print output sheets 1201 illustrated in FIG. 12 are the 20 sheets that have been printed and output by the above-described copy print job. The print output sheets 1201 are sequentially input to the checking apparatus 102, from a first print output sheet 1202 to a twentieth print output sheet 1215, and checking determination is performed thereon.

Since the first print output sheet 1202 is not determined as checking NG, the CPU in controller 102A proceeds to the steps illustrated in FIG. 10 in the order of step S1001, step S1002, step S1003, step S1010, and step S1009.

Further, since the checking results of the second, third, and fourth print output sheets are not determined as checking NG, the CPU in controller 102A similarly proceeds in the flow chart in the above-described order. When such a process is being performed, the CPU in the controller 102A does not transmit the output destination change information to the finisher unit 103 as in step S1011 illustrated in FIG. 10. The first print output sheet 1202 to the fourth print output sheet 1203 are thus discharged and stacked on the same output tray 525 in the sheet sorting unit 502.

Next, the fifth print output sheet 1204 is determined as checking NG, so that the CPU in the controller 102A proceeds to the steps illustrated in FIG. 10 in the order of step S1001, step S1002, step S1003, step S1004, step S1005, step S1006, step S1007, step S1008, and step S1009. In such a case, in step S1007, the CPU in the controller 102A transmits the checking NG information to the finisher unit 103, and the fifth print output sheet 1204 is thus discharged to the escape tray 513 at the sheet conveyance switching unit 501, and not conveyed to the sheet sorting unit 502.

The sixth print output sheet 1205 is not determined as NG as a result of the checking determination, while the fifth printed sheet 1204 one before the sixth print output sheet 1205 is determined as checking NG. The CPU in the controller 102A thus proceeds to the steps illustrated in FIG. 10 in the order of step S1001, step S1002, step S1003, step S1010, step S1011, step S1012, and step S1009. In such a case, in step S1011, the CPU in the controller 102A transmits the output destination change information to the finisher unit 103, so that the sixth print output sheet 1205 is output to the output tray 526 in the sheet sorting unit 502. As a result, the print output sheet is stacked on an output destination different from that of the first print output sheet 1202 to the fourth print output sheet 1203.

Next, the print output sheets from a seventh print output sheet 1206 to a eleventh print output sheet 1207 are not determined as checking NG. The CPU in the controller 102A thus proceeds to the steps illustrated in FIG. 10 in the order of step S1001, step S1002, step S1003, step S1010, and step S1009. When the process is being performed, each of the print output sheets from the seventh print output sheet 1206 to the eleventh print output sheet 1207 are output to the output tray 526 in the sheet sorting unit 502, and are thus discharged and stacked on the same output tray as that of the sixth print output sheet.

Next, the twelfth print output sheet 1208 is determined as NG as a result of the checking processing, so that the CPU in the controller 102A proceeds to the steps illustrated in FIG. 10 in the order of step S1001, step S1002, step S1003, step S1004, step S1005, step S1006, step S1007, step S1008, and step S1009. In such a case, in step S1007, the CPU in the controller 102A transmits the checking NG information to the finisher unit 103. The twelfth print output sheet 1208 is thus discharged to the escape tray 513 at the sheet conveyance switching unit 501, and switch control of the sheet discharge destination is performed not to convey the twelfth print output sheet 1208 to the sheet sorting unit 502.

Next, the thirteenth print output sheet 1209 is determined as NG as a result of the checking processing, so that the CPU in the controller 102A proceeds to the steps illustrated in FIG. 10 in the order of step S1001, step S1002, step S1003, step S1004, step S1005, step S1006, step S1007, step S1008, and step S1009.

In such a case, in step S1007, the CPU in the controller 102A also transmits the checking NG information to the finisher unit 103, so that the thirteenth print output sheet 1209 is discharged to the escape tray 513 at the sheet conveyance switching unit 501 switching the sheet discharge destination. The CPU in the controller 102A thus performs control of the conveyance destination of the print output sheet, and the print output sheet is not conveyed to the sheet sorting unit 502.

Next, the fourteenth print output sheet 1210 is not determined as NG as a result of the checking processing, while t the thirteenth print output sheet 1209 one before the fourteenth print output sheet 1210 is determined as checking NG. The CPU in the controller 102A thus proceeds to the steps illustrated in FIG. 10 in the order of step S1001, step S1002, step S1003, step S1010, step S1011, step S1012, and step S1009. In such a case, in step S1011, the CPU in the controller 102A transmits the output destination change information to the finisher unit 103, so that the fourteenth print output sheet 1210 is output to the output tray 527 in the sheet sorting unit 502. As a result, the print output sheet is stacked on an output destination different from that of the sixth print output sheet 1205 to the eleventh print output sheet 1207.

Next, each of the print output sheet from the fifteenth print output sheet 1211 to the seventeenth print output sheet 1212 are not determined as NG as a result of the checking determination. The CPT in the controller 102A thus proceeds to the steps illustrated in FIG. 10 in the order of step S1001, step S1002, step S1003, step S1010, and step S1009. When the process is being performed, each of the print output sheets from the fifteenth print output sheet 1211 to the seventeenth print output sheet 1212 are output to the output tray 527 in the sheet sorting unit 502, and are thus discharged and stacked on the same output tray as that of the fourteenth print output sheet 1210.

Next, the eighteenth print output sheet 1213 is determined as NG as a result of the checking processing, so that the CPU in the controller 102A proceeds to the steps illustrated in FIG. 10 in the order of step S1001, step S1002, step S1003, step S1004, step S1005, step S1006, step S1007, step S1008, and step S1009. In such a case, in step S1007, the CPU in the controller 102A transmits the checking NG information to the finisher unit 103, and the eighteenth print output sheet 1213 is thus discharged to the escape tray 513 at the sheet conveyance switching unit 501, and controlled not to be conveyed to the sheet sorting unit 502.

Next, the nineteenth print output sheet 1214 is not determined as NG as a result of the checking processing, while the eighteenth print output sheet 1213 one before the nineteenth print output sheet 1214 is determined as NG. The CPU in the controller 102A thus proceeds to the steps illustrated in FIG. 10 in the order of step S1001, step S1002, step S1003, step S1010, step S1011, step S1012, and step S1009. In such a case, in step S1011, the CPU in the controller 102A transmits the output destination change information to the finisher unit 103, so that the nineteenth print output sheet 1214 is output to the output tray 528 in the sheet sorting unit 502. As a result, the print output sheet is stacked on an output destination different from the fourteenth print output sheet 1210 to the seventeenth print output sheet 1212.

Next, the twentieth print output sheet 1215 is not determined as NG as a result of the checking processing, so that the CPU in the controller 102A proceeds to the steps illustrated in FIG. 10 in the order of step S1001, step S1002, step S1003, step S1010, and step S1009. When the process is being performed, the twentieth print output sheet 1215 is output to the output tray 528 in the sheet sorting unit 502, and stacked on the same output unit as that of the nineteenth print output sheet 1214.

As described above, the checking determination processing of the copy print job including 20 print output sheets is completed, and the CPU in the controller 102A jumps to step S1014 illustrated in FIG. 10. In such a case, the CPU in the controller 102A transmits to the image forming apparatus control unit 203 the information on the print output sheets which have been determined as checking NG. The processing result can thus be displayed on the operation unit 207, and the user can be prompted to determine whether to perform recovery printing with respect to the print output sheets which have been determined as checking NG.

Recovery printing of the print output sheets which have been determined as checking NG will be described below. In copy print output job, the process performed after the print output sheets have been sorted and discharged to output trays different between previous to and subsequent to an error in one copy print job according to the process illustrated in FIG. 10 will be described below. More specifically, recovery print control for reprinting the print output sheets which have been determined as NG as a result of the checking processing in the above-described process will be described below.

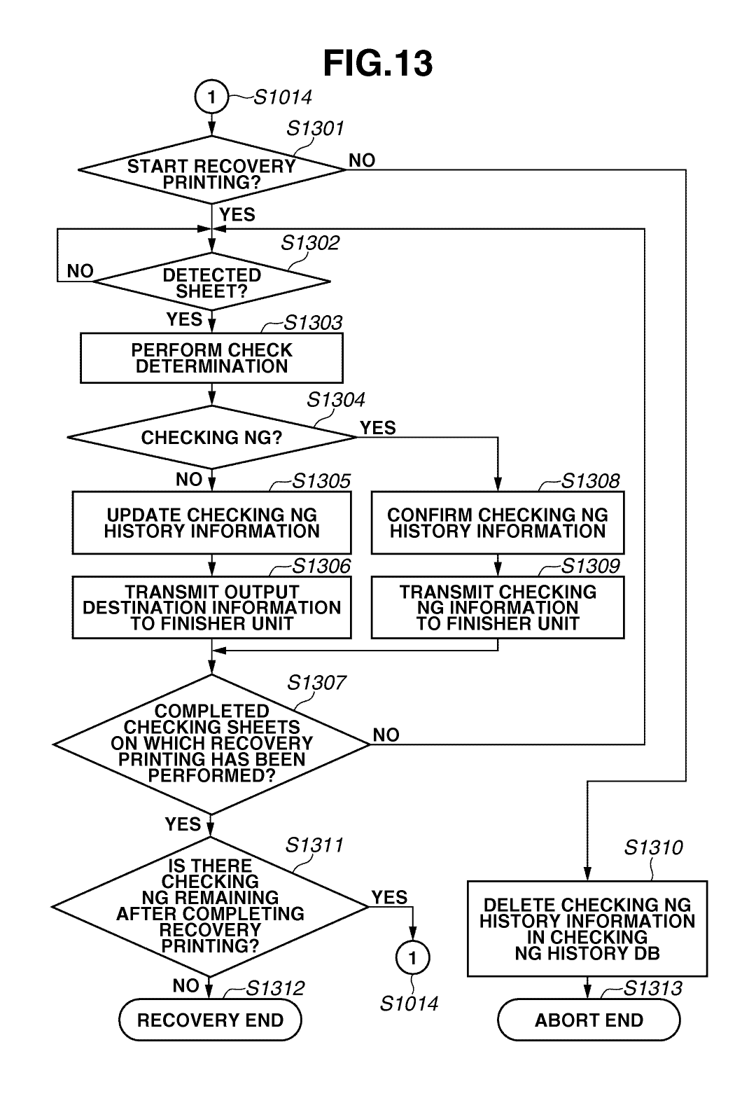

FIG. 13 is a flowchart illustrating a control method of the image forming system according to the present exemplary embodiment. The process illustrates an example of recovery processing executed after the print output sheets have been sorted and discharged to output trays different between previous to and subsequent to the error. Each of the steps in the flowchart is realized by the controller 102A including the CPU, the ROM, the RAM, the input/output I/F, which performs checking determination control in the checking apparatus 102, and the CPU in the image forming apparatus control unit 203 executing each process. Further, description will be made such that each of the CPU mainly operates as the determination unit.

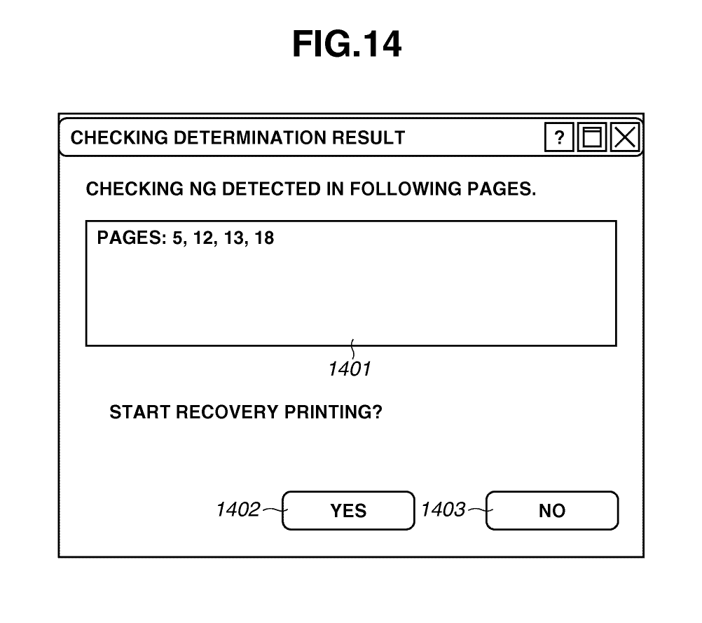

In step S1014 illustrated in FIG. 10, the CPU causes the user to select whether to perform recovery printing in the case where it is determined as NG in the checking processing as after once performing copy print output. In such a case, the CPU in the image forming apparatus control unit 203 displays on a display area 1401 on the operation unit 207 illustrated in FIG. 14, the information on the sheets which have been determined as checking NG. The information is displayed by the operation unit 207 receiving the information in the checking NG history DB 1110 stored in the checking apparatus 102.

FIG. 14 illustrates an example of the UI screen of the image forming apparatus according to the present exemplary embodiment. Referring to FIG. 14, the display area 1401 displays information on the pages in which NGs have been detected in the checking processing, i.e., pages 5, 12, 13, and 18. Buttons 1402 and 1403 function as buttons for instructing recovery printing to be started (i.e., button 1402) and cancelling recovery printing (i.e., button 1403).

The user can select by pressing either of the buttons 1402 and 1403 to instruct whether to perform copy print output (i.e., perform recovery printing) of only the sheets which have been determined as NG in the checking processing, or not perform recovery printing. In step S1301 illustrated in FIG. 13, the CPU in the image forming apparatus control unit 203 thus determines whether the user has operated on the operation unit 207 and has issued an instruction via the button 1402 or the button 1403 illustrated in FIG. 14.

If the CPU in the image forming apparatus control unit 203 determines that the user has pressed the button 1402 for requesting recovery printing to be started (YES in step S1301), the CPU in the image forming apparatus control unit 203 proceeds to step S1302. In step S1301, if the CPU in the image forming apparatus control unit 203 determines that the user has pressed the button 1403 (NO in step S1301), the process proceeds to step S1310. In this way, in step S1301, if the CPU in the image forming apparatus control unit 203 determines to start recovery printing (Yes in step s1302), the CPU in the image forming apparatus control unit 203 proceeds to step S1302.

In step S1302, the CPU in the controller 102A determines whether the print output sheet which has been recovery-printed is detected to have been conveyed to the checking apparatus 102. If the CPU in the controller 102A determines that the print output sheet which has been recovery-printed has not been detected (NO in step S1302), the CPU in the controller 102A waits until the print output sheet which has been recovery-printed is detected. On the other hand, if the CPU in the controller 102A determines that the printed sheet which has been recovery-printed has been detected (YES in step S1302), the CPU in the controller 102A proceeds to step S1303.

In step S1303 and step S1304, the CPU in the controller 102A determines whether the print output sheet conveyed to the checking apparatus 102 is NG as a result of the checking processing, using the checking determination method similar to those described with reference to FIGS. 9A, 9B, and 9C. If the CPU in the controller 102A determines that the result of the checking determination processing is not NG (NO in step S1304), the CPU in the controller 102A proceeds to step S1305. If the CPU in the controller 102A determines that the result of the checking determination processing is NG (YES in step S1304), the CPU in the controller 102A proceeds to step S1308.

In step S1305, the CPU in the controller 102A updates the checking NG information stored in the checking NG history DB 1110. More specifically, the CPU in the controller 102A deletes from the checking NG information stored in the checking NG history DB 1110, the information on the print output sheet which has been determined as not NG in the checking processing in step S1304. The order of the printed sheets previously input to the checking apparatus 102 in performing recovery printing is the same as the order stored in the checking NG history DB 1110. The CPU in the controller 102A thus updates the history information 1103 stored in the checking NG history DB 1110 in the order of having performed the checking processing.

In step S1306, the CPU in the controller 102A transmits to the finisher unit 103 the output destination information of the sheet which has been determined as not checking NG. In this case, the CPU in the controller 102A transmits the output destination information in the output destination ID 1104 stored in the checking NG history DB 1110. On the other hand, in step S1304, if the CPU in the controller 102A determines that the recovery print output sheet, which is input, is NG as a result of the checking processing, the CPU in the controller 102A proceeds to step S1308.

On the other hand, in step S1308, the CPU in the controller 102A confirms that the print output sheet is determined as checking NG again by referring to the history information 1103 corresponding to the sheet which has been determined as NG as a result of the checking processing. The history information 1103 may be managed by being associated with number information (not illustrated) so that the number of times the printed sheet has been continuously determined as checking NG is stored.

In step S1309, the CPU in the controller 102A transmits to the finisher control unit 601 the output destination change information to change the output destination of the print output sheet. As a result, the print output sheet which is determined as checking NG is discharged to the escape tray 513 and is thus prevented from being discharged to the normal output unit.

In step S1307, the CPU in the controller 102A determines whether the checking determination processing has been completed for the number of sheets on which recovery printing has been performed. If the CPU in the controller 102A determines that the checking determination processing has been completed for the number of sheets on which recovery printing has been performed (YES in step S1307), the CPU in the controller 102A proceeds to step S1311. In step S1311, the CPU in the controller 102A determines whether recovery printing has been completed without any checking NG.

If the CPU in the controller 102A has determined in step S1304 that there is no NG as a result of the checking processing, the history information 1103 of the relevant print output sheet is deleted in step S1305. As a result, if the history information is not recorded in the checking NG history DB 1110, the CPU in the controller 102A determines that recovery printing has been completed without any checking NG. If there is one or more of the history information recorded in the checking NG history DB 1110, the CPU in the controller 102A determines that recovery printing has been completed including a checking NG.

If the CPU in the controller 102A determines that recovery printing has been completed without any checking NG (NO in step S1311), the process proceeds to step S1312. In step S1312, recovery printing normally ends. On the other hand, if the CPU in the controller 102A determines that recovery printing has been completed including a checking NG (YES in step S1311), the CPU in the controller 102A jumps to step S1014. In step S1014, the user is caused to determine whether to perform recovery printing again as illustrated in FIG. 10.

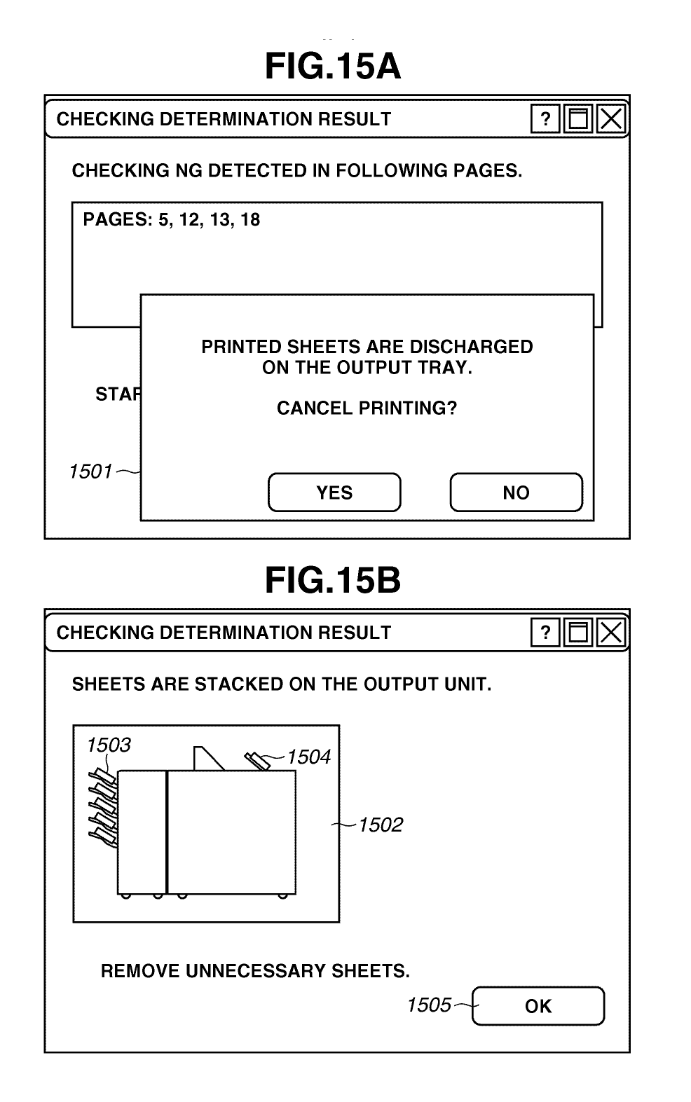

The case where, in step S1301, the CPU in the image forming apparatus control unit 203 determines that recovery printing is not to be started (NO in step S1301) will be described below. In such a case, the CPU in the image forming apparatus control unit 203 determines that the user is pressing the button 1403 in the UI screen illustrated in FIG. 14, which means, for example, that the printed sheets output and stacked on the output trays 525, 526, 527, 528, and 529 are to be discarded. The CPU in the controller 102A then proceeds to step S1310, and the CPU in the controller 102A deletes all of the checking NG history information stored in the checking NG history DB 1110. The CPU in the image forming apparatus control unit 203 may display on the operation unit 207 using the UI screen 1501 illustrated in FIG. 15A, an inquiry to the user on whether to cancel recovery printing.

The CPU in the image forming apparatus control unit 203 then proceeds to step S1313. In step S1313, the process ends without performing recovery printing. In such a case, the printed sheets which have been previously output are stacked on the output trays 525, 526, 527, 528, and 529 and the escape tray 513. The CPU in the image forming apparatus control unit 203 may thus display on the operation unit 207 using the UI screen illustrated in FIG. 15B, a screen prompting the user to remove the output sheets to prevent the user from forgetting to remove the output sheets.

Referring to FIG. 15B, the CPU in the image forming apparatus control unit 203 displays on a status display unit 1502 on the operation unit 207, two types of display as follows. The CPU in the image forming apparatus control unit 203 displays a status display 1503 indicating that the output sheets are stacked on the output trays, and a status display 1504 indicating that the output sheets are stacked on the escape tray. The user can thus be prompted to remove each of the output sheets stacked on each output unit. Further, if the user confirms the UI screen illustrated in FIG. 15B and presses a button 1505, the displays can be cleared from the operation unit 207.

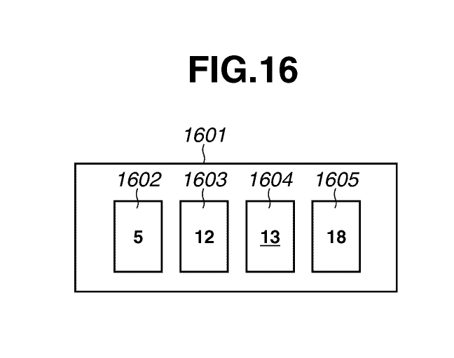

The operations performed by the checking apparatus 102 and the finisher unit 103 in the case where recovery printing is executed will be described below by using each figure with reference to an exemplary example illustrated FIG. 16. Referring to FIG. 16, four sheets are printed in total in the recovery printing process. The sheets illustrated in FIG. 16 are the sheets which have been determined as NG as a result of the checking processing determination when the copy print job described with reference to FIG. 12 has been executed. Printed sheet information of the sheets are stored in the checking NG history DB 1110 as described above, and the CPU in the image forming apparatus control unit 203 is capable of determining the sheets to be reprinted from the history information by receiving the notification from the CPU in the controller 102A. Further, it is assumed that the thirteenth recovery print output sheet is again determined as NG as a result of the checking processing, and the other recovery print output sheets is not determined as NG as a result of the checking processing.

In such a case, the operation unit 207 displays the UI screen illustrated in FIG. 14. If the CPU in the image forming apparatus control unit 203 then determines that the user has pressed the button 1402 for starting recovery printing, the CPU in the image forming apparatus control unit 203 proceeds from step S1301 to step S1302 in FIG. 13. At the same time, the CPU in the image forming apparatus control unit 203 reads each of the document stored in the memory unit 204 at the same time as printing each page when executing the initial copy print job. The CPU in the image forming apparatus control unit 203 then reads from the read image data, page image data corresponding to the sheet which is determined as checking NG among the information in the checking NG history DB 1110. The CPU in the image forming apparatus control unit 203 sequentially transfers the read image data to the output image processing unit 205. As a result, the CPU in the image forming apparatus control unit 203 starts the recovery printing operation without re-reading the document from the input image processing unit 201.

The CPU in the image forming apparatus control unit 203 thus sequentially prints the image data corresponding to the fifth printed sheet 1204, the twelfth printed sheet 1208, the thirteenth printed sheet 1209, and the eighteenth printed sheet 1213. A recovery-printed sheet corresponding to the fifth sheet 1602, a recovery-printed sheet corresponding to the twelfth sheet 1602, a recovery-printed sheet corresponding to the thirteenth sheet 1603, and a recovery-printed sheet corresponding to the eighteenth sheet 1605 are sequentially conveyed to the checking apparatus 102.

If it is determined that the recovery-printed sheet corresponding to the fifth sheet 1602 is conveyed to the checking apparatus 102, the CPU in the image forming apparatus control unit 203 proceeds from step S1302 to step S1303, and the CPU in the controller 102A performs the checking determination processing. Since the recovery-printed sheet 1602 is not determined as NG as a result of the checking processing illustrated in FIG. 16, the process proceeds from step S1304 to step S1305, and to step S1306. In step S1306, the CPU in the controller 102A can determine that the output destination of the recovery-printed sheet corresponding to the fifth sheet 1602 is the output tray 525, so that the recovery-printed sheet corresponding to the fifth sheet 1602 is output and stacked on the output tray 525. As a result, the recovery-print output sheet corresponding to the fifth sheet 1602 is discharged and stacked on top of the fourth print output sheet 1203 which has been output and stacked when the initial copy print job has been executed.

If it is then determined that the recovery-printed sheet corresponding to the twelfth sheet 1603 is input to the checking apparatus 102, the process also proceeds from step S1302 to step S1303, and the CPU in the controller 102A performs the checking determination processing. Since the recovery-printed sheet 1603 is not determined as NG as a result of the checking processing illustrated in FIG. 16, the process proceeds from step S1304 to step S1305, and to step S1306. In step S1306, the CPU in the controller 102A can determine that the output destination of the recovery-printed sheet corresponding to the twelfth sheet 1603 is the output tray 526, so that the recovery-print output sheet corresponding to the twelfth sheet 1603 is output and stacked on the output tray 526. As a result, the recovery-print output sheet corresponding to the twelfth sheet 1603 is discharged and stacked on top of the eleventh print output sheet 1207 which has been output and stacked when the initial copy print job has been executed.

If it is then determined that the recovery-print output sheet corresponding to the thirteenth sheet 1604 is input to the checking apparatus 102, the process also proceeds from step S1302 to step S1303, and the CPU in the controller 102A performs the checking determination processing. Since the recovery-print output sheet 1604 is determined as NG as a result of the checking processing illustrated in FIG. 16, the process proceeds from step S1304 to step S1308, and to step S1309. In step S1308, the CPU in the controller 102A confirms from the information stored in the checking NG history DB 1110 that the recovery-print output sheet corresponding to the thirteenth sheet 1604 is determined as NG as a result of the re-checking processing. The CPU in the controller 102A then re-stores the history information corresponding to the thirteenth print output sheet without deleting, for performing subsequent recovery printing.

In step S1309, the CPU in the controller 102A transmits to the finisher unit 103 the checking NG information to change to the escape tray 513 the output destination of the recovery-print output sheet corresponding to the thirteenth sheet 1604. As a result, the recovery-print output sheet corresponding to the thirteenth sheet 1604 is discharged to and stacked on the escape tray 513 at the conveyance path switching unit 511 in the sheet conveyance switching unit 501.

If it is further determined that the recovery-print output sheet corresponding to the eighteenth sheet 1605 is input to the checking apparatus 102, the process also proceeds from step S1302 to step S1303, and the CPU in the controller 102A performs the checking determination processing. Since the recovery-print output sheet 1605 is not determined as NG as a result of the checking processing illustrated in FIG. 16, the process proceeds from step S1304 to step S1305, and to step S1306. In step S1306, the CPU in the controller 102A can recognize from the information stored in the NG checking history DB 1110 that the output destination of the recovery-print output sheet corresponding to the eighteenth sheet 1605 is the output tray 527. The recovery-print output sheet corresponding to the eighteenth sheet 1605 is thus conveyed and stacked on the output tray 527. As a result, recovery-print output sheet corresponding to the eighteenth sheet 1605 is discharged and stacked on the seventeenth printed sheet 1212 which has been output and stacked when the initial copy print job has been executed.

Furthermore, when recovery printing of the recovery-print output sheet corresponding to the thirteenth sheet 1604 is re-performed, and the recovery-print output sheet is determined as not NG as a result of the checking processing, the recovery-print output sheet corresponding to the thirteenth sheet 1604 is conveyed to the output tray 526. The recovery-print output sheet corresponding to the thirteenth sheet 1604 is thus discharged and stacked on the twelfth printed sheet 1208.

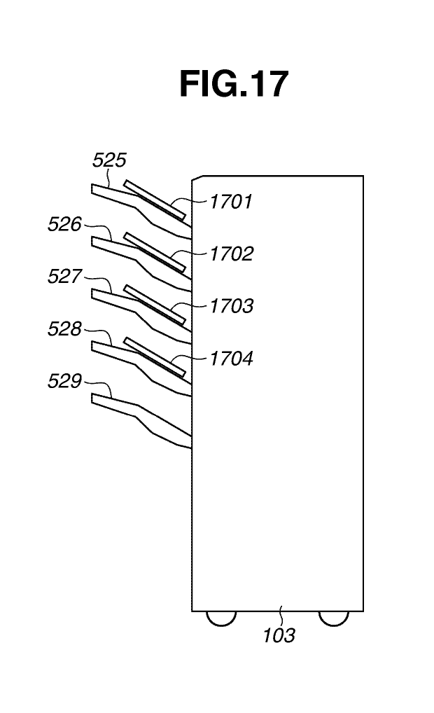

As described above, when printing of all sheets has been completed, each of the printed sheets are output and stacked on the output trays. A sheet bundle 1701 including the first, second, third, fourth, and fifth print output sheets is thus stacked on the output tray 525 as illustrated in FIG. 17.

Referring to FIG. 17, a sheet bundle 1702 including the sheets from the sixth print output sheet to the thirteenth printed sheet is similarly stacked on the output tray 526. Further, a sheet bundle 1703 including the sheets from the fourteenth print output sheet to the eighteenth print output sheet is similarly stacked on the output tray 527, and a sheet bundle 1704 including the nineteenth print output sheet and the twentieth print output sheet is similarly stacked on the output tray 528.

The user then stacks each of the print output sheet bundles stacked on the above-described four output trays in the order of the sheet bundle 1701, the sheet bundle 1702, the sheet bundle 1703, and the sheet bundle 1704. As a result, the user can easily acquire the sheet bundle in which the print output sheets are arranged in order from the first print output sheet to the twentieth print output sheet without worrying about the stacking order. In other words, the finisher control unit 601 controls the sheet discharge destinations so that the printed sheets which have been reprinted by the image forming apparatus 101 and determined by the checking apparatus 102 as normally printed are discharged to the output trays identified by the identification information of the output trays.

According to the present exemplary embodiment, the case where one-sided printing is performed is described for ease of description. In the case where two-sided printing is to be performed, the checking sensor reads the printed sheet from below the conveyance belt 402 as described above with reference to FIGS. 4A and 4B. As a result, both the front and the back side can be read at the same time, and the checking determination can thus be performed. Further, two-sided printing is available by associating two pages to one sheet to manage the NG checking history DB 1110. In such a case, if one of the front or back side of the same sheet is determined as checking NG, it becomes necessary to perform recovery printing of the page image data of both the front and back sides.

The second exemplary embodiment will be described below. According to the present exemplary embodiment, the number of output trays to be switched to when the checking result is determined as NG as described in the first exemplary embodiment is less than the number of sheets which are actually determined as NG as a result of checking processing. The control method of the finisher unit 103 performed in such a case will be described below. According to the present exemplary embodiment, the system configuration example illustrated in FIG. 1 and the configuration of the finisher unit 103 illustrated in FIG. 4 are the same, and description will thus be omitted.

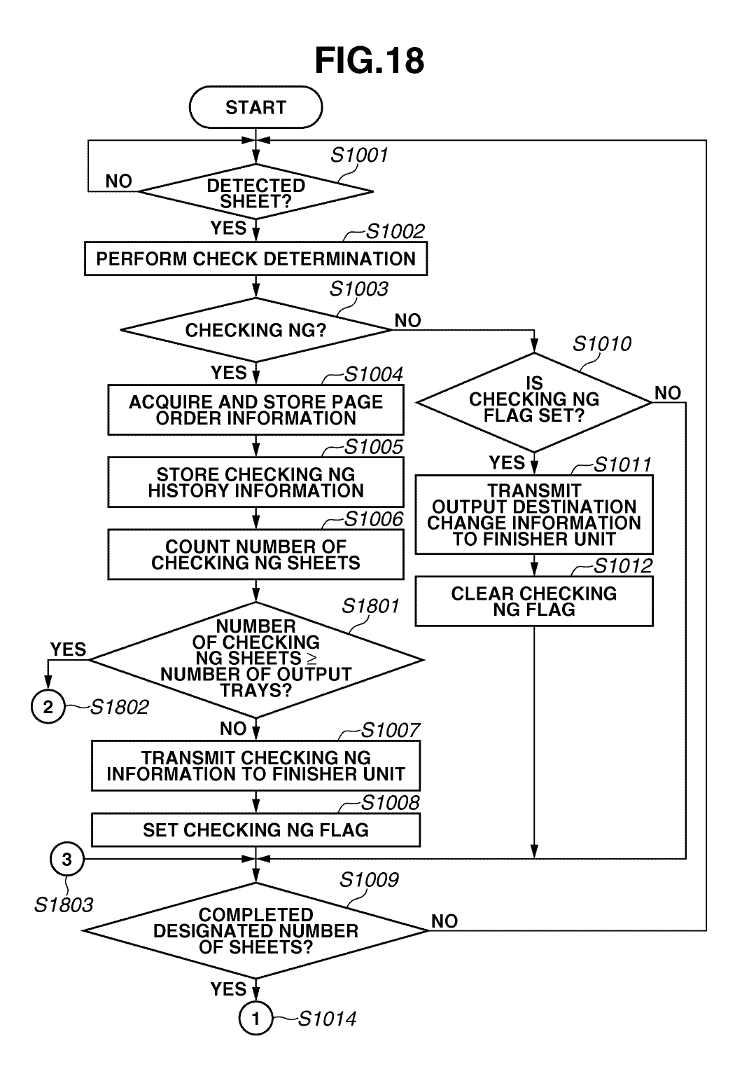

FIG. 18 is a flowchart illustrating the control method of the checking processing according to the present exemplary embodiment. The example illustrated in FIG. 18 is a checking processing performed by the checking apparatus included in the image forming system illustrated in FIG. 1. Each of the steps in the flowchart is realized by the controller 102A including the CPU, the ROM, the RAM, the input/output I/F, which performs checking determination control in the checking apparatus 102 executing each step. Further, description will be made such that the CPU mainly operates as the determination unit. Furthermore, according to the present exemplary embodiment, a copy job will be described below for ease of description. However, a print job via the network may also be similarly checked and printed.

The difference between the series of processings illustrated in FIG. 10 and the series of processings illustrated in FIG. 18 is that step S1801, i.e., a determination step, is inserted between step S1006 and step S1007 in the above-described flowchart illustrated in FIG. 10. The processing then branches from step S1801 to either step S1007 or to step S1802. Since the flowchart illustrated in FIG. 18 is proximately the same as that of the flowchart illustrated in FIG. 10, only the necessary portions according to the present exemplary embodiment will be described below.

In step S1001, the CPU in the controller 102A determines whether the print output sheet 410 has been conveyed to the checking apparatus 102. If the CPU in the controller 102A determines that the print output sheet has not been conveyed (NO in step S1001), the CPU waits in step S1001 until the print output sheet is detected. If the CPU in the controller 102A determines that the print output sheet has been conveyed (YES in step S1001), the CPU in the controller 102A proceeds to step S1002.

In step S1002 and step S1003, the CPU in the controller 102A determines whether the result of the checking processing for the input and detected print output sheet 410 is NG. If the CPU in the controller 102A determines that the result of the checking processing determination is NG (YES in step S1003), the CPU in the controller 102A proceeds to step S1004. In step S1004, the CPU in the controller 102A acquires and stores the order information of the print output sheet which has been determined as checking NG.

In step S1005, the CPU in the controller 102A stores the output destination information as the checking NG history information. The output destination information indicates the output destination to which the print output sheet which is determined as NG as a result of the checking processing was originally to be conveyed. The output destination is one of the output trays 525, 526, 527, 528, and 529 in the sheet sorting unit 502.

The CPU in the controller 102A may store the output destination information combined with the page order information acquired in step S1004. For example, the history information 1103 illustrated in FIG. 11 includes the combination of the sheet number 1105 indicating the order of the sheet which is determined as checking NG, and the output destination ID 1104. The history information 1103 is sequentially stored in the checking NG history DB 1110. According to the present exemplary embodiment, the output destination ID becomes as follows. ID=1 is assigned to the output tray 525 in the sheet sorting unit 502, ID=2 to the output tray 526, ID=3 to the output tray 527, ID=4 to the output tray 528, and ID=5 to the output tray 529.

In step S1006, the CPU in the controller 102A counts the number of checking NG sheets. In step S1801, the CPU in the controller 102A compares the number of checking NG sheets counted in step S1006 with the number of output trays usable in the copy print job. The CPU in the controller 102A then determines whether the number of checking NG sheets is greater than or equal to the number of output trays.

If the CPU in the controller 102A determines that the number of checking NG sheet is greater than or equal to the number of output trays (YES in step S1801), the CPU in the controller 102A jumps to step S1802. If the CPU in the controller 102A determines that the number of checking NG sheet is less than the number of output trays (NO in step S1801), the CPU in the controller 102A proceeds to step S1007. In step S1007, the CPU in the controller 102A transmits to the finisher control unit 601 the checking NG information for conveying to the escape tray the sheet which is determined as NG as a result of the checking processing. In step S1008, the CPU in the controller 102A sets the checking NG flag. Since the subsequent steps are the same as the first exemplary embodiment, description will be omitted.

If the process is to return to the flowchart illustrated in FIG. 18 as a result of performing the process flow subsequent to step S1802, the process returns to step S1803. In such a case, the process proceeds to step S1009, and the checking determination processing can be performed on the subsequent print output sheet.

In the above-described process illustrated in FIG. 18, if the output tray is switched every time the checking NG determination occurs as described in step S1801, if the checking NG determination occurs more than or equal to the predetermined number of output trays, there is no other output destination. To solve such a problem, the process flow is performed between step S1802 and step S1803 to switch the processing method for such a case. According to the present exemplary embodiment, it is particularly necessary to designate, when performing the checking process in executing the copy print job, the number of output trays in the sheet sorting unit 502 usable in the copy print job.

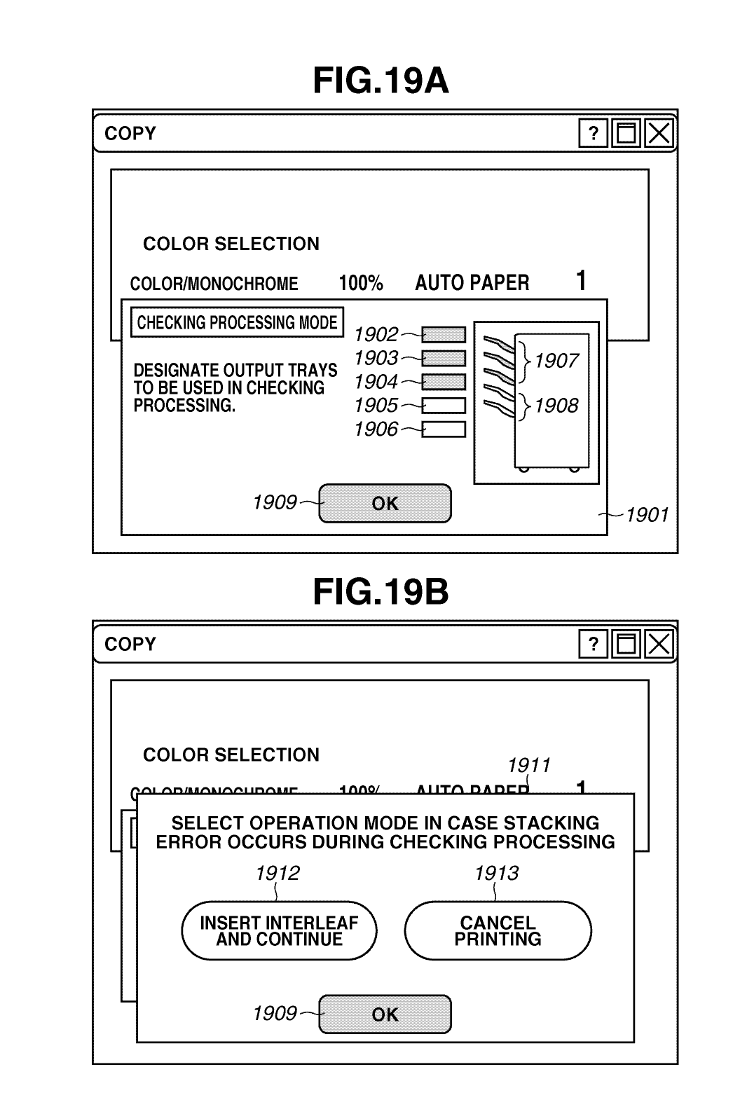

For example, the UI screen illustrated in FIG. 19A may be provided. If the user then designates on the operation unit 207 execution of the checking process, the user can designate the output trays to be used in the copy print job.

FIGS. 19A and 19B illustrate examples of the UI screens in which, when the checking processing is to be performed, details of a checking processing mode is displayed in a display area 1901 on the operation unit 207. Referring to FIG. 19A, the user can select on the UI screen the output tray to be used from the output trays 525, 526, 527, 528, and 529 in the sheet sorting unit 502 that are usable when performing the checking processing. Selection buttons 1902, 1903, 1904, 1905, and 1906 respectively correspond to the output trays 525, 526, 527, 528, and 529 in the sheet sorting unit 502. If the user presses the selection button 1902, the output tray 525 is selected as the output tray to be used in the checking processing. According to the present exemplary embodiment, the user presses the selection buttons 1902, 1903, and 1904, so that the output trays 525, 526, and 527 in the sheet sorting unit 502 are selected and used.

In the example illustrated in FIG. 19A, the user has pressed the selection buttons 1902, 1903, and 1904, so that the output trays 525, 526, and 527 in the sheet sorting unit 502 are to be used in the copy print job. If the CPU in the controller 102A then determines that the user has pressed a button 1909 to complete selecting the output trays, the CPU in the controller 102A displays the UI screen illustrated in FIG. 19B on the operation unit 207. FIG. 19B illustrates an example in which the UI screen displays in a display area 1911 a notification to the user that a stacking error has occurred while performing checking.

The display area 1911 is displayed on the operation unit 207 when the number of times to be determined as NG as a result of checking processing in the checking determination processing becomes greater than or equal to the designated number of the output trays, and the output tray cannot be changed so that the process cannot be continued. In such a case, the user can select using buttons 1912 and 1913, either of a first processing (i.e., an interleaf insert mode in which an interleaf is inserted and the process is continued) and a second processing (i.e., a print cancel mode).

The button 1912 is for selecting the operation mode for continuing, when the above-described stacking error has occurred, the checking determination process by inserting the interleaf in the position of the sheet which has been determined as NG as a result of the checking processing. In such a case, it becomes necessary for the user to insert, when the checking determination processing has ended, the printed sheet acquired by performing recovery printing. However, since the interleaf is inserted in the position in which the printed sheet is to be inserted, the operation is easier as compared to a conventional operation.

On the other hand, the user presses the button 1913 to select the operation mode for cancelling, when the above-described stacking error has occurred, the print output job. In such a case, if the above-described stacking error has occurred, the subsequent printed sheets are conveyed to the escape tray 513, and the image forming apparatus 101 cancels the printing operation.

FIG. 20 is a flowchart illustrating the control method of the checking processing according to the present exemplary embodiment. The example illustrated in FIG. 20 is a detailed procedure of control performed in step S1802 to step S1803 illustrated in FIG. 17. Each of the steps in the flowchart is realized by the controller 102 A including the CPU, the ROM, the RAM, the input/output I/F, which performs checking determination control in the checking apparatus 102 executing each steps. Further, description will be made such that the CPU mainly operates as the determination unit. The process for transmitting, when the number of pages stored in the RAM in the controller 102A exceeds the number of output trays included in the finisher unit 103 corresponding to the first sheet discharge unit, the notification for cancelling the job to the image forming apparatus 101 and the finisher unit 103 will be describe below. In such a case, the CPU in the controller 102A displays on the operation unit 207 the UI screens illustrated in FIGS. 19A and 19B.

Step S1802 in FIG. 20 is a branching point in the case where the number of times of occurrence of the checking NG has become greater than or equal to the number of output trays. In step S2001, the CPU in the controller 102A determines whether the user has selected the interleaf insert mode. The CPU in the controller 102A determines based on the operation selected by the user using the mode selection buttons described with reference to FIG. 19B. If the user has selected before executing the copy print job, the button 1912 in the display area 1911, the mode is the interleaf insert mode (INTERLEAF INSERT MODE in step S2001). The CPU in the controller 102A then proceeds to step S2002. If the user has selected before executing the copy print job, the button 1913 in the display area 1911, the mode is the print cancel mode (PRINT CANCEL MODE in step S2001). The process then proceeds to step S2004.

In step S2001, the CPU in the controller 102A determines whether the operation mode requested by the user is the print cancel mode from the button the user has operated on in the operation unit 207 using the UI screen illustrated in FIG. 19B. If the CPU in the controller 102A determines that the operation mode requested by the user is the print cancel mode, the CPU in the controller 102A proceeds to step S2004. In step S2004, the CPU in the controller 102A transmits to the image forming apparatus 101, image forming cancel information. The image forming apparatus control unit 203 in the image forming apparatus 101 then stops the paper feed/conveyance unit from conveying the sheets to cancel printing, and performs control to immediately stop printing the page image currently being printed.

In step S2005, the CPU in the controller 102A transmits the output destination change information to the finisher unit 103, and outputs to the escape tray 513 the print output sheet which has been determined as checking NG and the subsequently conveyed print output sheets. In step S2006, the CPU in the controller 102A confirms whether all print output sheets have been discharged. The CPU in the controller 102A may determine using a sheet detection sensor (not illustrated) disposed in the conveyance path switching unit 511 which counts the number of input print output sheets, and comparing the result with the sheet number information input in step S2004 and the subsequent steps. Alternatively, the CPU in the controller 102A may determine that all printed sheets have been discharged when predetermined time has elapsed.

As described above, the CPU in the controller 102A controls each unit in the print cancel mode, and in step S2007, the processing ends. The CPU in the controller 102A may perform control to display on the operation unit 207 that printing has been cancelled due to the print cancel mode, and a stacking state of the print output sheets stored in the checking NG history DB 1110.

On the other hand, in step S2001, if the CPU in the controller 102A determines that the operation mode requested by the user is the interleaf insert mode, the CPU in the controller 102A proceeds to step S2002. In step S2002, the CPU in the controller 102A transmits to the finisher unit 103 the checking NG information to change the output destination of the print output sheet. In such a case, the sheet conveyance switching unit 501 switches the conveyance direction when the print output sheet is input, so that the print output sheet which is determined as NG as a result of the checking processing is discharged to the escape tray 513.

In step S2003, the CPU in the controller 102A transmits to the finisher unit 103, interleaf insert request information to output the interleaf to the output tray unit in place of the print output sheet discharged to the escape tray 513. In such a case, the sheet conveyance switching unit 501 switches the conveyance path switching unit 512 so that the interleaf conveyed from the inserter 514 is inserted. Further, the inserter 514 inserts the interleaf to the conveyance path at appropriate timing in place of the printed sheet previously discharged to the escape tray 513. The CPU in the controller 102A then jumps to step S1803 illustrated in FIG. 18, and the processing illustrated in FIG. 18 is performed.

As described above, the CPU in the controller 102A performs control based on the interleaf insert mode as illustrated in step S2001 to step S2003. If the subsequent sheet is determined as NG as a result of the checking processing, the CPU in the controller 102A proceeds from step S2001 to step S2002, and to step S2003. The CPU in the controller 102A discharges to the escape tray 513 the print output sheet which has been determined as NG as the checking processing, and discharges the interleaf to the output tray.

There may be a case where, when the print output sheet and the interleaf are continuously conveyed to and stacked on the output tray 527, the number of sheets that can be stacked on each output tray is set due to a limit on a height of the sheet bundle that can be stacked. In such a case, a unit for counting the number of sheets stacked on the output tray is disposed on each output tray, and if it is determined that the number has reached the threshold value or greater, the finisher unit 103 may transmit to the image forming apparatus 101 the print cancel information.

As described above, according to the present exemplary embodiment, if the print job is continuously performed by switching the output tray when the print output sheet is determined as checking NG, and there is no output tray to change to, printing can be continued by selecting the interleaf insert mode. Further, if the sheet acquired by performing recovery printing is to be inserted in the output sheet bundle after printing, the sheet can be easily inserted by inserting in the position where the interleaf is inserted. The sheet to be discharged may be discharged by shifting with respect to the sheet discharged immediately before the sheet, i.e., shift-discharged, instead of inserting the interleaf. If there is no interleaf in a sheet feed source after performing the interleaf insert mode for inserting the interleaf, the shift-discharged may be performed.

According to the present exemplary embodiment, the CPU in the checking apparatus 102 performs various types of control. However, the image forming apparatus control unit 203 in the image forming apparatus 101 may instruct the checking apparatus 102 and perform control. Further, if there is no output tray to be changed to in the print cancel mode, printing is cancelled, so that excessive printing can be prevented. Furthermore, the image forming apparatus control unit 203 may function as a first control unit, a second control unit, and a third control unit.

According to the above-described exemplary embodiment, a normally printed product discharged before the printed product determined as NG in the checking processing, and the printed product discharged after the printed product determined as NG are discharged to different discharge trays. However, the present invention is not limited thereto, and the normally printed product discharged before the printed product determined as NG may be discharged in a shifted state on the same discharge tray as the printed product discharged after the printed product determined as NG.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-263388 filed Dec. 1, 2011, which is hereby incorporated by reference herein in its entirety.

What is claimed is:

1. A checking apparatus for checking a printed product comprising:
a determination unit configured to check whether the printed product is normal; and
a control unit configured to control, in the case where the determination unit has determined that the printed product is normal, the printed product to be discharged to a first sheet discharge unit, in the case where the determination unit has then determined that the printed product is not normal, the printed product to be discharged to a second sheet discharge unit different from the first sheet discharge unit, and in the case where the determination unit has further determined that the printed product is normal, the printed product to be discharged to a third sheet discharge unit different from the first sheet discharge unit and the second sheet discharge unit.

2. The checking apparatus according to claim 1, further comprising a reprint control unit configured to control, in the case where the determination unit determines that the printed product is not normal, reprinting of a substitute printed product for the printed product.

3. The checking apparatus according to claim 2, wherein the control unit controls discharging to the first sheet discharge unit the substitute printed product for the printed product.

4. The checking apparatus according to claim 1, further comprising a display unit configured to display information on the printed product determined by the determination unit as not normal.

5. The checking apparatus according to claim 1, further comprising a selection unit configured to select among a plurality of sheet discharge units, a sheet discharge unit to be used for discharging the printed product,
wherein the third sheet discharge unit is determined from sheet discharge units selected by the selection unit.

6. A control method for controlling a checking apparatus for checking a printed product, the method comprising:
checking whether the printed product is normal; and
controlling, in the case where the printed product is determined as normal, the printed product to be discharged to a first sheet discharge unit, in the case where the printed product is then determined as not normal, the printed product to be discharged to a second sheet discharge unit different from the first sheet discharge unit, and in the case where the printed product is further determined as normal, the printed product to be discharged to a third sheet discharge unit different from the first sheet discharge unit and the second sheet discharge unit.

7. A computer-readable storage medium for storing a computer program for controlling a checking apparatus for checking a printed product, the program comprising:
a code to check whether the printed product is normal; and
a code to control, in the case where the printed product is determined as normal, the printed product to be discharged to a first sheet discharge unit, in the case where the printed product is then determined as not normal, the printed product to be discharged to a second sheet discharge unit different from the first sheet discharge unit, and in the case where the printed product is further determined as normal, the printed product to be discharged to a third sheet discharge unit different from the first sheet discharge unit and the second sheet discharge unit.
